(19) United States
(12) Patent Application Publication
(10) Pub. No.: US 2023/0312143 A1
(43) Pub. Date: Oct. 5, 2023

(54) Tandem Rotor Unmanned Aerial Vehicle and Attitude Adjustment Control Method

(71) Applicant: Beihang University, Beijing (CN)

(72) Inventors: Jiang WU, Beijing (CN); Enmin CHEN, Beijing (CN); Yijie GAO, Beijing (CN); Xiaodong FAN, Beijing (CN); Kaixiang ZHANG, Beijing (CN); Tianyi TAN, Beijing (CN)

(21) Appl. No.: 18/129,211

(22) Filed: Mar. 31, 2023

(30) Foreign Application Priority Data
Apr. 2, 2022 (CN) 202210351390.1

(51) Int. Cl. B64U 10/13; B64C 27/50; G05D 1/08

(52) U.S. Cl. CPC B64U 10/13; B64C 27/50; G05D 1/0858

(57) ABSTRACT

The present disclosure provides a tandem rotor unmanned aerial vehicle, which includes a vehicle body, a flight control system, and a propulsion system. The propulsion system includes a front distributed propulsion system and a rear distributed propulsion system. The front distributed propulsion system is arranged at a front end of the vehicle body. The rear distributed propulsion system is arranged a rear end of the vehicle body. The front distributed propulsion system includes rotor blades, a rotor nose, a main shaft, a speed reducer, a synchronizer, a motor, and a periodic variable pitch mechanism. A polar attitude of the tandem rotor unmanned aerial vehicle of the present disclosure can be adjusted conveniently and stably in the air, and the adjustment efficiency is high. The present disclosure further provides an attitude adjustment control method for the tandem rotor unmanned aerial vehicle.

### CROSS-REFERENCE TO RELATED APPLICATION

This patent application claims the benefit and priority of Chinese Patent Application No. 202210351390.1, filed with the China National Intellectual Property Administration on Apr. 2, 2022, the disclosure of which is incorporated by reference herein in its entirety as part of the present application.

### TECHNICAL FIELD

The present disclosure relates to the technical field of unmanned aerial vehicles, and in particular, to a tandem rotor unmanned aerial vehicle and an attitude adjustment control method.

### BACKGROUND

In environments of complex terrain, wide space, rapid emergency rescue, and the like, unmanned aerial vehicles which can respond quickly and are launched by cartridge ejection or box emission are applied more and more widely. In order to facilitate carrying and storage, wings are folded before the unmanned aerial vehicles are launched, and are unfolded after the unmanned aerial vehicles are ejected or rockets are launched to a certain height or distance. The unmanned aerial vehicles launched by ejection or booster rocket emission have become a major development and application direction of rapidly deployed emergency rescue or disaster relief unmanned aerial vehicles.

Compared with a fixed-wing unmanned aerial vehicle, a tandem rotor unmanned aerial vehicle has the characteristics of large load, high hover efficiency, and the like. Therefore, it is applied more in scenarios such as emergency rescue delivery and material delivery. However, most of the existing unmanned aerial vehicles that are launched by cartridge ejection or box emission have fixed wings, which are difficult to give full play to the advantages of rotorcrafts in application scenarios such as maritime or mountain emergency rescue. Therefore, taking off the tandem rotor unmanned aerial vehicle in an ejection mode is a hot spot of current engineering research. The fastness and the reliability of the unfolding of a rotor of the tandem rotor unmanned aerial vehicle after being launched have problems about attitude stability and the like because the unmanned aerial vehicle is affected by various factors during an unfolding stage of the rotor. Complex problems such as the stability and the robustness of attitude control of the tandem rotor unmanned aerial vehicle need to be solved urgently.

### SUMMARY

The present disclosure aims to overcome at least one of the technical defects in the related art.

In view of this, a purpose of the present disclosure is to provide a tandem rotor unmanned aerial vehicle to solve the problem mentioned in the BACKGROUND and overcome the deficiencies in the related art.

In order to achieve the abovementioned purpose, an embodiment in an aspect of the present disclosure is to provide a tandem rotor unmanned aerial vehicle, which includes a vehicle body, a flight control system, and a propulsion system. The propulsion system includes a front distributed propulsion system and a rear distributed propulsion system. The front distributed propulsion system is arranged at a front end of the vehicle body. The rear distributed propulsion system is arranged a rear end of the vehicle body. The front distributed propulsion system includes rotor blades, a rotor nose, a main shaft, a speed reducer, a synchronizer, a motor, and a periodic variable pitch mechanism. The rotor blades are connected to the rotor nose. The rotor nose is connected to the main shaft. An output end of the motor is connected to the speed reducer. The speed reducer is connected to the synchronizer. The main shaft is connected to the speed reducer. The motor drives the main shaft to rotate through the speed reducer. The periodic variable pitch mechanism includes a steering engine set and an automatic tilter. An output end of the steering engine set is connected to the automatic tilter. The automatic tilter is arranged on the main shaft in a sleeving manner. The automatic tilter is connected to the rotor nose. The automatic tilter changes tilt directions of the rotor blades through the rotor nose. The steering engine set includes three steering engines. The flight control system controls the motor and the steering engine set to realize attitude adjustment of the tandem rotor unmanned aerial vehicle.

Preferably, the rear distributed propulsion system has the same structure as the front distributed propulsion system.

In any of the above solutions, preferably, the flight control system controls an attitude adjustment loop of the tandem rotor unmanned aerial vehicle by combining a linear quadratic regulation algorithm and an L1 adaptive control algorithm to realize attitude adjustment of the tandem rotor unmanned aerial vehicle and ensure robust control of the attitude adjustment, which includes:
establishing a transverse and longitudinal linearization model of the tandem rotor unmanned aerial vehicle in different flight conditions, and designing a state feedback gain matrix of the transverse and longitudinal linearization model by using the linear quadratic regulation algorithm;
designing a full-order state observer according to the transverse and longitudinal linearization model, and combining an observation state quantity value output by the full-order state observer and a measurement value of a sensor to obtain an estimated value of a state variable and an estimated error of the state variable;
designing a parameter adaptive law to obtain an estimated value of a disturbance parameter according to the estimated error of the state variable;
designing an L1 adaptive controller of a transverse and longitudinal motion system to obtain a control input quantity according to the estimated value of the disturbance parameter, the estimated value of the state variable, the estimated error of the state variable, and a received desired attitude command signal; and
controlling the tandem rotor unmanned aerial vehicle to complete attitude adjustment according to the control input quantity.

In any of the above solutions, preferably, the transverse and longitudinal linearization model includes a lateral linearization model and a longitudinal linearization model. The control input quantity includes a lateral motion control input quantity and a longitudinal motion control input quantity. The L1 adaptive controller of the transverse and longitudinal motion system includes an L1 adaptive controller of a lateral motion system and an L1 adaptive controller of a longitudinal motion system. The L1 adaptive controller of the lateral motion system outputs the lateral motion control input quantity. The lateral motion control input quantity includes a transverse periodic variable pitch input quantity and a yaw control quantity. The L1 adaptive controller of the longitudinal motion system outputs the longitudinal motion control input quantity. The longitudinal motion control input quantity includes a collective pitch input quantity and a longitudinal periodic variable pitch input quantity. The state variable includes a transverse motion state variable and a longitudinal motion state variable. The full-order state observer includes a longitudinal full-order state observer and a lateral full-order state observer.

In any of the above solutions, preferably, the longitudinal linearization model of the tandem rotor unmanned aerial vehicle is expressed as:

\dot{x}θᵥ(t)=A_{θ}_{ᵥ}x_{θ}_{ᵥ}(t)+b_{θ}_{ᵥ}(ω(t)u(t)+θ^{T}(t)x_{θ}_{ᵥ}(t)+σ(t))

y_{θ}_{ᵥ}(t)=c_{θ}_{ᵥ}^{T}x_{θ}_{ᵥ}(t)

In the formula, x_{θ}_{ᵥ}(y) is the longitudinal motion state variable, \dot{x}_{θ}_{ᵥ}(t) is a change rate of the longitudinal motion state variable, y_{θ}_{ᵥ}(t) is a pitch attitude angle output quantity, A_{θ}_{ᵥ} is a longitudinal system state spatial matrix, b_{θ}_{ᵥ} is a longitudinal system state input matrix, and ω(t) is an input weight and is used for compensating an error of a system input matrix; u(t) is a longitudinal variable pitch input quantity, θ(t) is a longitudinal motion model disturbance parameter, θ^{T}(t) is a transpose of θ(t), σ(t) is an external environment disturbance parameter, c_{θ}_{ᵥ}^{T} is a longitudinal system state output matrix, and t is a time parameter.

For the longitudinal linearization model, an indicator function related to the longitudinal motion state variable and the longitudinal motion control input quantity is fit:

J=∫(x^{T}Qx+u^{T}Ru)dt

J is the indicator function, x is an error quantity matrix between a desired longitudinal motion state variable and a real longitudinal motion state variable, x^{T} is a transpose of x, u is a collective pitch input quantity and a longitudinal periodic variable pitch input matrix, and u^{T} is a transpose of u; Q is a longitudinal motion state variable weighted parameter matrix, R is a weighted parameter matrix of the longitudinal motion control input quantity, u=−Kₘx, Kₘ is a feedback gain matrix, and the solution of the feedback gain matrix Kₘ in the linear quadratic regulation algorithm is:

Kₘ=R⁻¹b_{θ}_{ᵥ}^{T}P

Where R⁻¹ is an inverse of R, b_{θ}_{ᵥ}^{T} is a transpose of b_{θ}_{ᵥ}, P is an intermediate parameter matrix, and P is obtained by solving the following Riccati equation:

A_{θ}_{ᵥ}^{T}P+PA_{θ}_{ᵥ}−Pb_{θ}_{ᵥ}R⁻¹b_{θ}_{ᵥ}P+Q=0

Where A_{θ}_{ᵥ}^{T} is a transpose of A_{θ}_{ᵥ}.

A longitudinal linearization model with a longitudinal motion state variable feedback is expressed as:

\dot{x}θᵥ(t)=Aₘx_{θ}_{ᵥ}(t)+b_{θ}_{ᵥ}(ω(t)u(t)+θ^{T}(t)x_{θ}_{ᵥ}(t)+σ(t))

y_{θ}_{ᵥ}(t)=c_{θ}_{ᵥ}^{T}x_{θ}_{ᵥ}(t)

Aₘ=A_{θ}_{ᵥ}−b_{θ}_{ᵥ}Kₘ

Where Aₘ is a longitudinal system state spatial feedback matrix.

In any of the above solutions, preferably, a specific expression formula of the longitudinal full-order state observer is as follows:

\hat{\dot{x}}θᵥ(t)=A_{θ}_{ᵥ}\hat{x}_{θ}_{ᵥ}(t)+b_{θ}_{ᵥ}(\hat{ω}(t)u(t)+\hat{θ}^{T}(t)x_{θ}_{ᵥ}(t)+\hat{σ}(t))

ŷ_{θ}_{ᵥ}(t)=c_{θ}_{ᵥ}^{T}\hat{x}_{θ}_{ᵥ}(t)

Where \hat{x}_{θ}_{ᵥ}(t) is an estimated value of the longitudinal motion state variable, \hat{\dot{x}}_{θ}_{ᵥ}(t) is a change rate of the estimated value of the longitudinal motion state variable, \hat{ω}(t) is an input weighted estimated value, \hat{θ}^{T}(t) is an estimated value of θ^{T}(t), \hat{σ}(t) is an estimated value of the external environment disturbance parameter; ŷ_{θ}_{ᵥ}(t) is an estimated value of a pitch attitude angle, and the estimated value \hat{x}_{θ}_{ᵥ}(t) of the longitudinal motion state variable is calculated.

An estimated error of the longitudinal motion state variable is as follows:

\tilde{\dot{x}}θᵥ(t)=A_{θ}_{ᵥ}\tilde{x}_{θ}_{ᵥ}(t)+b_{θ}_{ᵥ}(\tilde{ω}(t)u(t)+\tilde{θ}^{T}(t)x_{θ}_{ᵥ}(t)+\tilde{σ}(t))

\tilde{x}_{θ}_{ᵥ}(0)=0

\tilde{θ}(t)=\hat{θ}(t)−θ(t)

\tilde{x}_{θ}_{ᵥ}(t)=\hat{x}_{θ}_{ᵥ}(t)−x_{θ}_{ᵥ}(t)

\tilde{ω}(t)=\hat{ω}(t)−ω(t)

\tilde{σ}(t)=\hat{σ}(t)−σ(t)
wherein \tilde{\dot{x}}_{θ}_{ᵥ}(t) is a change rate of the estimated error of the longitudinal motion state variable, \tilde{x}_{θ}_{ᵥ} (t) is the estimated error of the longitudinal motion state variable, \tilde{ω}(t) is an input weighted estimated error, \hat{θ}(t) is an estimated value of the longitudinal motion model disturbance parameter, \tilde{θ}(t) is an estimated error of the longitudinal motion model disturbance parameter, and \tilde{σ}(t) is an estimated error of the external environment disturbance parameter;

In any of the above solutions, preferably, the parameter adaptive law is designed to obtain \hat{θ}(t), \hat{σ}(t), and \hat{ω}(t) according to the estimated error of the longitudinal motion state variable; and an adaptive law calculation formula is as follows:

\hat{\dot{θ}}(t)=ΓProj(\hat{θ}(t),− [symbol] (t)Pb_{θ}_{ᵥ}x_{θ}_{ᵥ}(t)),\hat{θ}(0)=\hat{θ}₀

\hat{\dot{σ}}(t)=ΓProj(\hat{σ}(t),−\tilde{x}_{θ}_{ᵥ}^{T}(t)Pb_{θ}_{ᵥ}),\hat{σ}(0)=\hat{σ}₀

\hat{\dot{ω}}(t)=ΓProj(\hat{ω}(t),−\tilde{x}_{θ}_{ᵥ}^{T}(t)Pb_{θ}_{ᵥ}u_{ad}(t)),\hat{ω}(0)=\hat{ω}₀

Where \hat{\dot{θ}}(t) is a change rate of the estimated value of the longitudinal motion model disturbance parameter, \hat{\dot{σ}}(t) is a change rate of the estimated value of the external environment disturbance parameter, and \hat{\dot{ω}}(t) is a change rate of the input weighted estimated value.

The L1 adaptive controller of the longitudinal motion system is designed and the longitudinal motion control input quantity is output according to the estimated value \hat{θ}(t) of the longitudinal motion model disturbance parameter, the estimated value \hat{σ}(t) of the external environment disturbance parameter, the input weighted estimated value \hat{ω}(t), the estimated value \hat{x}_{θ}_{ᵥ}(t) of the longitudinal motion state variable, the estimated error \tilde{x}_{θ}_{ᵥ}(t) of the longitudinal motion state variable, and the received desired attitude command signal.

In any of the above solutions, preferably, a specific form of the designed L1 adaptive controller u_{ad}(t) is as follows:

u_{ad}(s)=−kD(s)(\hat{η}(s)−k_{g}r(s))

Where u_{ad}(t) is a combination of the longitudinal periodic variable pitch input quantity and the collective pitch input quantity, u_{ad}(s) is the Laplace transform of u_{ad}(t), r(s) is the Laplace transform of a command input r(t), \hat{η}(s) is the Laplace transform of \hat{η}(t), and \hat{η}(t)=\hat{ω}(t)u_{ad}(t)+\hat{θ}^{T}x_{θ}_{ᵥ}(t)+\hat{σ}(t) k_{g} is a gain of the command input, and k_{g}=−1/(c_{θ}_{ᵥ}^{T} Aₘ⁻¹b_{θ}_{ᵥ}); and D(s) is a strictly positive real transfer function,

$$D ( s ) = \frac{1}{s} ,$$

s expresses a s domain, and k is an adaptive feedback gain.

The present disclosure further discloses an attitude adjustment control method for a tandem rotor unmanned aerial vehicle. The method controls an attitude adjustment loop of the tandem rotor unmanned aerial vehicle by combining a linear quadratic regulation algorithm and an L1 adaptive control algorithm to realize attitude adjustment of the tandem rotor unmanned aerial vehicle and ensure robust control of the attitude adjustment, which specifically includes:

S1: establishing a transverse and longitudinal linearization model of the tandem rotor unmanned aerial vehicle in different flight conditions, and designing a state feedback gain matrix for the transverse and longitudinal linearization model through a Linear Quadratic Regulator (LQR).

S2: designing a longitudinal full-order state observer according to the transverse and longitudinal linearization model established in S1, and combining with a measurement value of a sensor to obtain an estimated value of a state variable and an estimated error of the state variable;

S3: designing a parameter adaptive law to obtain an estimated value of a disturbance parameter according to the estimated error of the state variable obtained in S2;

S4: designing an L1 adaptive controller of a transverse and longitudinal motion system to obtain a control input quantity according to the estimated value of the disturbance parameter obtained in S3, the estimated value of the state variable obtained in S2, the estimated error of the state variable, and a received desired attitude command signal; and

S5: controlling the tandem rotor unmanned aerial vehicle to complete attitude adjustment according to the control input quantity.

Preferably, the transverse and longitudinal linearization model includes a lateral linearization model and a longitudinal linearization model. The control input quantity includes a lateral motion control input quantity and a longitudinal motion control input quantity. The L1 adaptive controller of the transverse and longitudinal motion system includes an L1 adaptive controller of a lateral motion system and an L1 adaptive controller of a longitudinal motion system. The L1 adaptive controller of the lateral motion system outputs the lateral motion control input quantity. The lateral motion control input quantity includes a transverse periodic variable pitch input quantity and a yaw control quantity. The L1 adaptive controller of the longitudinal motion system outputs the longitudinal motion control input quantity. The longitudinal motion control input quantity includes a collective pitch input quantity and a longitudinal periodic variable pitch input quantity. The state variable includes a transverse motion state variable and a longitudinal motion state variable. The full-order state observer includes a longitudinal full-order state observer and a lateral full-order state observer.

In any of the above solutions, preferably, after S1, the method further includes:

S11: expressing the longitudinal linearization model of the tandem rotor unmanned aerial vehicle as:

\dot{x}θᵥ(t)=A_{θ}_{ᵥ}x_{θ}_{ᵥ}(t)+b_{θ}_{ᵥ}(ω(t)u(t)+θ^{T}(t)x_{θ}_{ᵥ}(t)+σ(t))

y_{θ}_{ᵥ}(t)=c_{θ}_{ᵥ}^{T}x_{θ}_{ᵥ}(t)

In the formula, x_{θ}_{ᵥ}(t) is the longitudinal motion state variable, \dot{x}_{θ}_{ᵥ}(t) is a change rate of the longitudinal motion state variable, y_{θ}_{ᵥ}(t) is a pitch attitude angle output quantity, A_{θ}_{ᵥ} is a longitudinal system state spatial matrix, b_{θ}_{ᵥ} is a longitudinal system state matrix; and ω(t) is an input weight and is used for compensating an error of a system input matrix; u(t) is a longitudinal variable pitch input quantity, θ(t) is a longitudinal motion model disturbance parameter, θ^{T}(t) is a transposition of θ(t), σ(t) is an external environment disturbance parameter, c_{θ}_{ᵥ}^{T} is a longitudinal system state output matrix, and t is a time parameter.

For the longitudinal linearization model, an indicator function related to the longitudinal motion state variable and the longitudinal motion control input quantity is fit:

J=∫(x^{T}Qx+u^{T}Ru)dt

J is the indicator function, x is an error quantity matrix between a desired longitudinal motion state variable and a real longitudinal motion state variable, x^{T} is a transpose of x, u is a collective pitch input quantity and a longitudinal periodic variable pitch input matrix, and u^{T} is a transpose of u; Q is a longitudinal motion state variable weighted parameter matrix, R is a weighted parameter matrix of the longitudinal motion control input quantity, u=−Kₘx, Kₘ is a feedback gain matrix, and the solution of the feedback gain matrix Kₘ in the linear quadratic regulation algorithm is:

Kₘ=R⁻¹b_{θ}_{ᵥ}^{T}P

Where R⁻¹ is an inverse of R, b_{θ}_{ᵥ}^{T} is a transpose of b_{θ}_{ᵥ}, P is an intermediate parameter matrix, and P is obtained by solving the following Riccati equation:

A_{θ}_{ᵥ}^{T}P+PA_{θ}_{ᵥ}−Pb_{θ}_{ᵥ}R⁻¹b_{θ}_{ᵥ}P+Q=0

Where A_{θ}_{ᵥ}^{T} is a transpose of A_{θ}_{ᵥ}.

The longitudinal linearization model with a longitudinal motion state variable feedback is expressed as:

\dot{x}θᵥ(t)=Aₘx_{θ}_{ᵥ}(t)+b_{θ}_{ᵥ}(ω(t)u(t)+θ^{T}(t)x_{θ}_{ᵥ}(t)+σ(t))

y_{θ}_{ᵥ}(t)=c_{θ}_{ᵥ}^{T}x_{θ}_{ᵥ}(t)

Aₘ=A_{θ}_{ᵥ}−b_{θ}_{ᵥ}Kₘ

Where Aₘ is a longitudinal system state spatial feedback matrix.

In any of the above solutions, preferably, after S2, the method further includes S21: a specific expression formula of the longitudinal full-order state observer is as follows:

\hat{\dot{x}}θᵥ(t)=A_{θ}_{ᵥ}\hat{x}_{θ}_{ᵥ}(t)+b_{θ}_{ᵥ}(\hat{ω}(t)u(t)+\hat{θ}^{T}(t)x_{θ}_{ᵥ}(t)+\hat{σ}(t))

ŷ_{θ}_{ᵥ}(t)=c_{θ}_{ᵥ}^{T}\hat{x}_{θ}_{ᵥ}(t)

Where \hat{x}_{θ}_{ᵥ}(t) is an estimated value of the longitudinal motion state variable, \hat{\dot{x}}_{θ}_{ᵥ}(t) is a change rate of the estimated value of the longitudinal motion state variable, \hat{ω}(t) is an input weighted estimated value, \hat{θ}^{T}(t) is an estimated value of θ^{T}(t), and \hat{σ}(t) is an estimated value of the external environment disturbance parameter; and ŷ_{θ}_{ᵥ}(t) is an estimated value of a pitch attitude angle, and the estimated value \hat{x}_{θ}_{ᵥ}(t) of the longitudinal motion state variable is calculated.

An estimated error of the longitudinal motion state variable is as follows:

\tilde{\dot{x}}θᵥ(t)=A_{θ}_{ᵥ}\tilde{x}_{θ}_{ᵥ}(t)+b_{θ}_{ᵥ}(\tilde{ω}(t)u(t)+\tilde{θ}^{T}(t)x_{θ}_{ᵥ}(t)+\tilde{σ}(t))

\tilde{x}_{θ}_{ᵥ}(0)=0

\tilde{θ}(t)=\hat{θ}(t)−θ(t)

\tilde{x}_{θ}_{ᵥ}(t)=\hat{x}_{θ}_{ᵥ}(t)−x_{θ}_{ᵥ}(t)

\tilde{ω}(t)=\hat{ω}(t)−ω(t)

\tilde{σ}(t)=\hat{σ}(t)−σ(t)

Where \tilde{\dot{x}}_{θ}_{ᵥ}(t) is a change rate of the estimated error of the longitudinal motion state variable, \tilde{x}_{θ}_{ᵥ} (t) is the estimated error of the longitudinal motion state variable, \tilde{ω}(t) is an input weighted estimated error, \hat{θ}(t) is an estimated value of the longitudinal motion model disturbance parameter, \tilde{θ}(t) is an estimated error of the longitudinal motion model disturbance parameter, and \tilde{σ}(t) is an estimated error of the external environment disturbance parameter.

In any of the above solutions, preferably, after S3, the method further includes S31: designing the parameter adaptive law to obtain \hat{θ}(t), \hat{σ}(t), and \hat{ω}(t) according to the estimated error of the longitudinal motion state variable; and an adaptive law calculation formula is as follows:

\hat{\dot{θ}}(t)=ΓProj(\hat{θ}(t),− [symbol] (t)Pb_{θ}_{ᵥ}x_{θ}_{ᵥ}(t)),\hat{θ}(0)=\hat{θ}₀

\hat{\dot{σ}}(t)=ΓProj(\hat{σ}(t),−\tilde{x}_{θ}_{ᵥ}^{T}(t)Pb_{θ}_{ᵥ}),\hat{σ}(0)=\hat{σ}₀

\hat{\dot{ω}}(t)=ΓProj(\hat{ω}(t),−\tilde{x}_{θ}_{ᵥ}^{T}(t)Pb_{θ}_{ᵥ}u_{ad}(t)),\hat{ω}(0)=\hat{ω}₀

Where \hat{\dot{θ}}(t) is a change rate of the estimated value of the longitudinal motion model disturbance parameter, \hat{\dot{σ}}(t) is a change rate of the estimated value of the external environment disturbance parameter, and \hat{\dot{ω}}(t) is a change rate of the input weighted estimated value.

The L1 adaptive controller of the longitudinal motion system is designed and the longitudinal motion control input quantity is output according to the estimated value \hat{θ}(t) of the longitudinal motion model disturbance parameter, the estimated value \hat{σ}(t) of the external environment disturbance parameter, the input weighted estimated value \hat{ω}(t), the estimated value \hat{x}_{θ}_{ᵥ}(t) of the longitudinal motion state variable, the estimated error \tilde{x}_{θ}_{ᵥ}(t) of the longitudinal motion state variable, and the received desired attitude command signal.

In any of the above solutions, preferably, after S4, the method further includes S41: designing a specific formula of the L1 adaptive controller of the longitudinal motion system as follows:

u_{ad}(s)=−kD(s)(\hat{η}(s)−k_{g}r(s))

Where u_{ad}(t) is a combination of the longitudinal periodic variable pitch input quantity and the collective pitch input quantity, u_{ad}(s) is the Laplace transform of u_{ad}(t), r(s) is the Laplace transform of a command input r(t), \hat{η}(s) is the Laplace transform of \hat{η}(t), \hat{η}(t)=\hat{ω}(t)u_{ad}(t)+\hat{θ}^{T}x_{θ}_{ᵥ}(t)+\hat{σ}(t); k_{g} is a gain of the command input, and k_{g}=−1/(c_{θ}_{ᵥ}^{T}Aₘ⁻¹b_{θ}_{ᵥ}); and D(s) is a strictly positive real transfer function,

$$D ( s ) = \frac{1}{s} ,$$

s expresses a s domain, and k is an adaptive feedback gain.

Compared with the related art, the present disclosure has the advantages and beneficial effects that:
1. The tandem rotor unmanned aerial vehicle of the present disclosure has a simple structure. The rotor blades are connected to the rotor nose. The rotor blades are subjected to folding and unfolding positioning through a hinge mechanism and a spring buckle locking mechanism. The flight control system controls the motor and the periodic variable pitch mechanism to realize the attitude adjustment of the tandem rotor unmanned aerial vehicle. The structure transmission is stable, so that the tandem rotor unmanned aerial vehicle can perform fast unfolding and adjustment of the rotors in the air, and the adjustment is more stable.
2. The attitude adjustment control method for the tandem rotor unmanned aerial vehicle of the present disclosure controls the rotating speed of the motor of a propulsion system and the periodic variable pitch mechanism through a pre-designed attitude control law, so as to realize fast unfolding and attitude adjustment control of the rotors of the tandem rotor unmanned aerial vehicle. The control is stable, the control efficiency is high, and robust and reliable control is provided for the unfolding and attitude adjustment of the rotors of the tandem rotor unmanned aerial vehicle.

Additional aspects and advantages of the present disclosure will be partially set forth in the following description, and some will become apparent from the following description, or will be understood by the practice of the present disclosure.

### BRIEF DESCRIPTION OF THE DRAWINGS

The above and/or additional aspects and advantages of the present disclosure will become apparent and readily understood from the description of the embodiments in combination with the accompanying drawings.

FIG. 1 is a schematic structural diagram of a tandem rotor unmanned aerial vehicle according to an embodiment of the present disclosure.

FIG. 2 is a schematic structural diagram of the front distributed propulsion system in the tandem rotor unmanned aerial vehicle according to an embodiment of the present disclosure.

FIG. 3 is a main view of the front distributed propulsion system of the tandem rotor unmanned aerial vehicle according to an embodiment of the present disclosure.

FIG. 4 is a schematic diagram of an L1 adaptive control structure in an attitude adjustment control method for a tandem rotor unmanned aerial vehicle.

FIG. 5 is a simulation diagram of a pitch angle 10° step response of an attitude loop of a tandem rotor unmanned aerial vehicle according to an embodiment of the present disclosure.

FIG. 6 is simulation diagram of a longitudinal periodic variable pitch input quantity during pitch angle step response control of a tandem rotor unmanned aerial vehicle according to an embodiment of the present disclosure.

FIG. 7 is a simulation diagram of a roll angle stable control response of a 10° disturbance of a tandem rotor unmanned aerial vehicle according to an embodiment of the present disclosure.

FIG. 8 is a simulation diagram of a transverse periodic variable pitch input quantity during roll angle stable control of a 10° disturbance of a tandem rotor unmanned aerial vehicle according to an embodiment of the present disclosure.

FIG. 9 is a simulation diagram of a yaw rate stable control response of a 1°/s disturbance of a tandem rotor unmanned aerial vehicle according to an embodiment of the present disclosure.

FIG. 10 is a simulation diagram of a yaw control input during yaw rate stable control of a 1°/s disturbance of a tandem rotor unmanned aerial vehicle according to an embodiment of the present disclosure.

FIG. 11 is a simulation diagram of a pitch angle output tracking response after a rotor of a tandem rotor unmanned aerial vehicle according to an embodiment of the present disclosure is unfolded.

FIG. 12 is a simulation diagram of a roll angle output tracking response of a tandem rotor unmanned aerial vehicle according to an embodiment of the present disclosure.

FIG. 13 is a simulation diagram of a yaw angle output tracking response of a tandem rotor unmanned aerial vehicle according to an embodiment of the present disclosure.

### REFERENCE SIGNS IN THE DRAWINGS

1—vehicle body; 2—rotor blade; 3—rotor nose; 4—main shaft; 5—speed reducer; 6—synchronizer; 7—motor; 8—automatic tilter; and 9—steering engine.

### DETAILED DESCRIPTION OF THE EMBODIMENTS

The embodiments of the present disclosure are described in detail below, and the examples of the embodiments are illustrated in the drawings, where the same or similar reference numerals throughout refer to the same or similar elements or elements having the same or similar functions. The embodiments described below with reference to the drawings are intended to be illustrative of the present disclosure and are not to be construed as a limitation to the present disclosure.

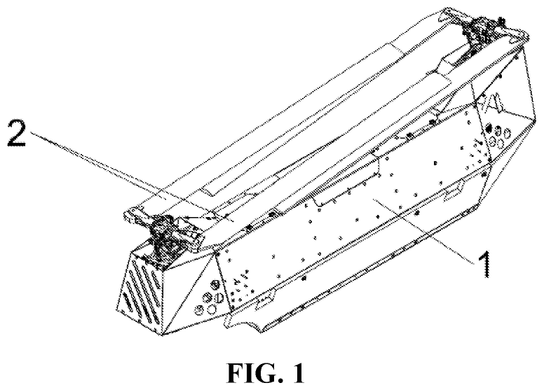

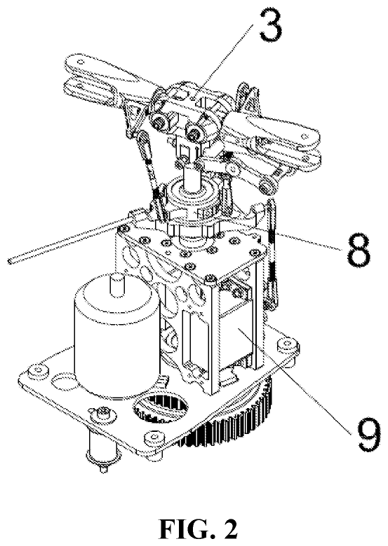

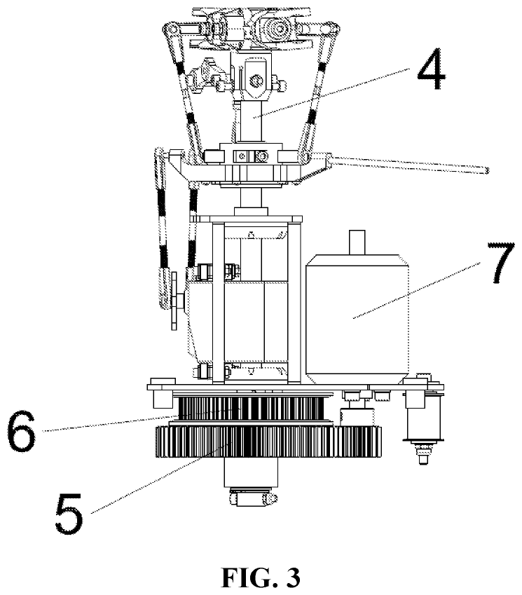

As shown in FIG. 1 to FIG. 3, a tandem rotor unmanned aerial vehicle according to an embodiment of the present disclosure includes a vehicle body 1, a flight control system, and a propulsion system. The propulsion system includes a front distributed propulsion system and a rear distributed propulsion system. The front distributed propulsion system is arranged at a front end of the vehicle body. The rear distributed propulsion system is arranged a rear end of the vehicle body. The front distributed propulsion system includes rotor blades 2, a rotor nose 3, a main shaft 4, a speed reducer 5, a synchronizer 6, a motor 7, and a periodic variable pitch mechanism. The rotor blades 2 are connected to the rotor nose 3. The rotor nose 3 is connected to the main shaft 4. An output end of the motor 7 is connected to the speed reducer 5. The speed reducer 5 is connected to the synchronizer 6. The main shaft 4 is connected to the speed reducer 5. The motor 7 drives the main shaft 4 to rotate through the speed reducer 5. The periodic variable pitch mechanism includes a steering engine set and an automatic tilter 8. An output end of the steering engine set is connected to the automatic tilter. The automatic tilter 8 is arranged on the main shaft 4 in a sleeving manner. The automatic tilter 8 is connected to the rotor nose 3. The automatic tilter 8 changes tilt directions of the rotor blades 2 through the rotor nose 3. The steering engine set includes three steering engines 9. An output end of each steering engine 9 is connected to the automatic tilter 8. The flight control system controls the motor and the steering engine set to realize attitude adjustment of the tandem rotor unmanned aerial vehicle.

The tandem rotor unmanned aerial vehicle of the present disclosure is simple in structure. During launching, unfolding actions of the rotors can be performed quickly, and a flight attitude can be adjusted in time through the periodic variable pitch mechanism, so the flight is safer and more stable.

Further, the rear distributed propulsion system has the same structure as the front distributed propulsion system.

After a booster rocket falls off, the flight control system controls the motor to drive the main shaft to rotate. The main shaft drives the rotors to unfold and rotate, and meanwhile, the tandem rotor unmanned aerial vehicle starts to perform attitude adjustment until a desired attitude is reached.

Specifically, the flight control system controls an attitude adjustment loop of the tandem rotor unmanned aerial vehicle by combining a linear quadratic regulation algorithm and an L1 adaptive control algorithm to realize attitude adjustment of the tandem rotor unmanned aerial vehicle and ensure robust control of the attitude adjustment, which includes that:
a transverse and longitudinal linearization model of the tandem rotor unmanned aerial vehicle in different flight conditions is established, and a state feedback gain matrix of the transverse and longitudinal linearization model is designed by using the linear quadratic regulation algorithm;
a full-order state observer is designed according to the transverse and longitudinal linearization model, and an observation state quantity value output by the full-order state observer and a measurement value of a sensor are combined to obtain an estimated value of a state variable and an estimated error of the state variable; the sensor is an attitude sensor, and is mounted inside the vehicle body to measure a real attitude value of the rotor unmanned aerial vehicle;
a parameter adaptive law is designed to obtain an estimated value of a disturbance parameter according to the estimated error of the state variable;
an L1 adaptive controller of a transverse and longitudinal motion system is designed to obtain a control input quantity according to the estimated value of the disturbance parameter, the estimated value of the state variable, the estimated error of the state variable, and a received desired attitude command signal; and
the tandem rotor unmanned aerial vehicle is controlled to complete attitude adjustment according to the control input quantity.

Specifically, the transverse and longitudinal linearization model includes a lateral linearization model and a longitudinal linearization model. The control input quantity includes a lateral motion control input quantity and a longitudinal motion control input quantity. The L1 adaptive controller of the transverse and longitudinal motion system includes an L1 adaptive controller of a lateral motion system and an L1 adaptive controller of a longitudinal motion system. The L1 adaptive controller of the lateral motion system outputs the lateral motion control input quantity. The lateral motion control input quantity includes a transverse periodic variable pitch input quantity and a yaw control quantity. The L1 adaptive controller of the longitudinal motion system outputs the longitudinal motion control input quantity. The longitudinal motion control input quantity includes a collective pitch input quantity and a longitudinal periodic variable pitch input quantity. The state variable includes a transverse motion state variable and a longitudinal motion state variable. The full-order state observer includes a longitudinal full-order state observer and a lateral full-order state observer.

The motor and the steering engine set are controlled according to the lateral motion control input quantity and the longitudinal motion control input quantity to realize quick attitude adjustment of the tandem rotor unmanned aerial vehicle.

An attitude adjustment control method for a tandem rotor unmanned aerial vehicle of an embodiment of the present disclosure has high control efficiency, greatly improves the stability and the robustness of attitude control, reduces the attitude adjustment failure rate in more launching processes, meanwhile, reduces more fuel cost, and has higher control accuracy.

Further, a longitudinal linearization model of the tandem rotor unmanned aerial vehicle is expressed as:

\dot{x}θᵥ(t)=A_{θ}_{ᵥ}x_{θ}_{ᵥ}(t)+b_{θ}_{ᵥ}(ω(t)u(t)+θ^{T}(t)x_{θ}_{ᵥ}(t)+σ(t))

y_{θ}_{ᵥ}(t)=c_{θ}_{ᵥ}^{T}x_{θ}_{ᵥ}(t)

In the formula, x_{θ}_{ᵥ}(t) is a longitudinal motion state variable. The longitudinal motion state variable includes: a forward speed quantity, a vertical speed quantity, a pitch rate quantity, and a pitch angle quantity. \dot{x}_{θ}_{ᵥ}(t) is a change rate of the longitudinal motion state variable, y_{θ}_{ᵥ}(t) is a pitch attitude angle output quantity, A_{θ}_{ᵥ} is a longitudinal system state spatial matrix, b_{θ}_{ᵥ} is a longitudinal system state input matrix, and ω(t) is an input weight and is used for compensating an error of a system input matrix; u(t) is a longitudinal variable pitch input quantity, θ(t) is a longitudinal motion model disturbance parameter, that is, a system error of a longitudinal motion model, θ^{T}(t) is a transpose of θ(t), σ(t) is an external environment disturbance parameter, that is, an influence error of the rotor unmanned aerial vehicle caused by external environment factors, c_{θ}_{ᵥ}^{T} is a longitudinal system state output matrix, and t is a time parameter.

Specifically, x_{θ}_{ᵥ}(t) is a column vector of 1×4, and θ(t) is a weighted parameter row vector of 1×4.

It is necessary to assume that the parameters in the model satisfy the following conditions:

Assumption 1: parameters θ(t) and σ(t) satisfy: θ(t)∈Θ, |σ(t)|≤Δ₀, ∀t≥0, where Θ is a known convex set, and Δ₀∈R⁺.

Assumption 2: parameters θ(t) and σ(t) are continuously differentiable and uniformly bounded:

∥\dot{θ}(t)∥≤d_{θ}<∞,|\dot{σ}(t)|≤d_{σ}<∞,∀t≥0

Assumption 3: the weighted parameter ω∈R satisfies: ω∈Ω₀∈[ω₁ ωᵤ].

For the longitudinal linearization model of the present disclosure, all assumptions above can be satisfied to ensure the reliability of the model.

For the longitudinal linearization model, an indicator function related to the longitudinal motion state variable and the longitudinal motion control input quantity is fit:

J=∫(x_{T}Qx+u_{T}Ru)dt

J is the indicator function, x is an error quantity matrix between a desired longitudinal motion state variable and a real longitudinal motion state variable, x^{T} is a transpose of x, u is a collective pitch input quantity and a longitudinal periodic variable pitch input matrix, and u^{T} is a transpose of u; Q is a longitudinal motion state variable weighted parameter matrix, R is a weighted parameter matrix of the longitudinal motion control input quantity, u=−Kₘx, specifically, Q is a 4×4 weighted parameter matrix, R is a 2×2 weighted parameter matrix, Kₘ is a feedback gain matrix, and Q and R in the indicator function respectively realize the weighting of the longitudinal motion state variable and the longitudinal periodic variable pitch input quantity. Both matrix Q and matrix R are diagonal positive semi-definite matrixes, elements on a diagonal line of the matrix Q directly affect the convergence rate of the corresponding longitudinal motion state variable, and elements on a diagonal line of the matrix R directly affect the energy magnitude of the longitudinal periodic variable pitch input quantity. The higher the convergence rate of the longitudinal motion state variable, the greater the energy of the longitudinal periodic variable pitch input quantity, and the higher the requirement on actuators such as a steering engine. The optimal control of a Linear Quadratic Regulator (LQR) is to select Q and R in advance according to a real model case to find out an appropriate feedback gain matrix Kₘ, and a feedback control input u=−Kₘx thereof optimizes the indicator function J; and the indicator function J is optimal when reaching a minimum value, and the optimal represents the most energy-saving state of the model.

The solution of the feedback gain matrix Kₘ in the linear quadratic regulation algorithm is:

Kₘ=R⁻¹b_{θ}_{ᵥ}^{T}P

Where R⁻¹ is an inverse of R, b_{θ}_{ᵥ}^{T} is a transpose of b_{θ}_{ᵥ}, P is an intermediate parameter matrix, and P is obtained by solving the following Riccati equation:

A_{θ}_{ᵥ}^{T}P+PA_{θ}_{ᵥ}−Pb_{θ}_{ᵥ}R⁻¹b_{θ}_{ᵥ}P+Q=0

Where A_{θ}_{ᵥ}^{T} is a transpose of A_{θ}_{ᵥ},

The longitudinal linearization model with a longitudinal motion state variable feedback is expressed as:

\dot{x}θᵥ(t)=Aₘx_{θ}_{ᵥ}(t)+b_{θ}_{ᵥ}(ω(t)u(t)+θ^{T}(t)x_{θ}_{ᵥ}(t)+σ(t))

y_{θ}_{ᵥ}(t)=c_{θ}_{ᵥ}^{T}x_{θ}_{ᵥ}(t)

Aₘ=A_{θ}_{ᵥ}−b_{θ}_{ᵥ}Kₘ

Where Aₘ is a longitudinal system state spatial feedback matrix.

Specifically, a specific expression formula of the longitudinal full-order state observer is as follows:

\hat{\dot{x}}θᵥ(t)=A_{θ}_{ᵥ}\hat{x}_{θ}_{ᵥ}(t)+b_{θ}_{ᵥ}(\hat{ω}(t)u(t)+\hat{θ}^{T}(t)x_{θ}_{ᵥ}(t)+\hat{σ}(t))

ŷ_{θ}_{ᵥ}(t)=c_{θ}_{ᵥ}^{T}\hat{x}_{θ}_{ᵥ}(t)

Where \hat{x}_{θ}_{ᵥ}(t) is an estimated value of the longitudinal motion state variable, \hat{\dot{x}}_{θ}_{ᵥ}(t) is a change rate of the estimated value of the longitudinal motion state variable, \hat{ω}(t) is an input weighted estimated value, \hat{θ}^{T}(t) is an estimated value of θ^{T}(t), \hat{σ}(t) is an estimated value of the external environment disturbance parameter; ŷ_{θ}_{ᵥ}(t) is an estimated value of a pitch attitude angle, and the estimated value \hat{x}_{θ}_{ᵥ}(t) of the longitudinal motion state variable is calculated.

Different from the above model expression formula, parameters \hat{ω}(t), \hat{θ}(t), and \hat{σ}(t) in the model are all estimated values calculated by the parameter adaptive law, and the longitudinal full-order state observer calculates and outputs an estimated value \hat{x}_{θ}_{ᵥ}(t) of the state variable. The deviation between the estimated value of the state variable and a real state variable is used for the calculation of the parameter adaptive law.

An estimated error of the longitudinal motion state variable is as follows:

\tilde{\dot{x}}θᵥ(t)=A_{θ}_{ᵥ}\tilde{x}_{θ}_{ᵥ}(t)+b_{θ}_{ᵥ}(\tilde{ω}(t)u(t)+\tilde{θ}^{T}(t)x_{θ}_{ᵥ}(t)+\tilde{σ}(t))

\tilde{x}_{θ}_{ᵥ}(0)=0

\tilde{θ}(t)=\hat{θ}(t)−θ(t)

\tilde{x}_{θ}_{ᵥ}(t)=\hat{x}_{θ}_{ᵥ}(t)−x_{θ}_{ᵥ}(t)

\tilde{ω}(t)=\hat{ω}(t)−ω(t)

\tilde{σ}(t)=\hat{σ}(t)−σ(t)

Where \tilde{\dot{x}}_{θ}_{ᵥ}(t) is a change rate of the estimated error of the longitudinal motion state variable, \tilde{x}_{θ}_{ᵥ} (t) is the estimated error of the longitudinal motion state variable, \tilde{ω}(t) is an input weighted estimated error, \hat{θ}(t) is an estimated value of the longitudinal motion model disturbance parameter, \tilde{θ}(t) is an estimated error of the longitudinal motion model disturbance parameter, and \tilde{σ}(t) is an estimated error of the external environment disturbance parameter. According to a relevant theorem of an L1 adaptive control theory, it can be proved that an estimated state error of the system is uniformly bounded.

The parameter adaptive law is designed to obtain \hat{θ}(t), \hat{σ}(t) and \hat{ω}(t) according to the estimated error of the longitudinal motion state variable; and an adaptive law calculation formula is as follows:

\hat{\dot{θ}}(t)=ΓProj(\hat{θ}(t),− [symbol] (t)Pb_{θ}_{ᵥ}x_{θ}_{ᵥ}(t)),\hat{θ}(0)=\hat{θ}₀

\hat{\dot{σ}}(t)=ΓProj(\hat{σ}(t),−\tilde{x}_{θ}_{ᵥ}^{T}(t)Pb_{θ}_{ᵥ}),\hat{σ}(0)=\hat{σ}₀

\hat{\dot{ω}}(t)=ΓProj(\hat{ω}(t),−\tilde{x}_{θ}_{ᵥ}^{T}(t)Pb_{θ}_{ᵥ}u_{ad}(t)),\hat{ω}(0)=\hat{ω}₀

Where \hat{\dot{θ}}(t) is a change rate of the estimated value of the longitudinal motion model disturbance parameter, \hat{\dot{σ}}(t) is a change rate of the estimated value of the external environment disturbance parameter, and \hat{\dot{ω}}(t) is a change rate of the input weighted estimated value; Γ∈R⁺ is an adaptive gain, and Proj(⋅) is a projection operator, which is specifically defined as follows:

$$Proj ( θ , y ) = \{ \begin{matrix}y , & f ( θ ) < 0 \\ y - \frac{∇ f ( θ )}{‖ ∇ f ( θ ) ‖} 〈 \frac{∇ f ( θ )}{‖ ∇ f ( θ ) ‖} , y 〉 f ( θ ) , & f ( θ ) \geq 0 , ∇ {f ( θ )}^{T} y > 0 \\ y , & f ( θ ) \geq 0 , ∇ {f ( θ )}^{T} y \leq 0\end{matrix}$$

Where ƒ:Rⁿ→R is a smooth convex function, which is specifically defined as follows:

$$f ( θ ) = \frac{( {ε}_{θ} + 1 ) {θ}^{T} θ - {θ}_{max}^{2}}{{ε}_{θ} {θ}_{max}^{2}}$$

Where θₘₐₓ is a boundary constraint of a vector θ; ε_{θ} is any small positive real number less than 1; and ∇ƒ(θ) is set as a gradient of ƒ(⋅) at θ.

P=P^{T} is substituted in the Lyapunov equation as follows:

Aₘ^{T}P+PAₘ=−Q

For the solution of any Q=Q^{T}, Aₘ^{T} is a transpose of a longitudinal system state spatial feedback matrix. For any value of Q, the solution of the P is unique. In combination with a longitudinal motion modeling case, it can be known that the input weighted parameter ω(t) and a longitudinal motion model disturbance parameter θ(t) are related to the weight, the rotational inertia, and the aerodynamic parameter of the tandem rotor unmanned aerial vehicle, and σ(t) is related to the disturbance of external environmental factors, such as wind.

The L1 adaptive controller of the longitudinal motion system is designed and the longitudinal motion control input quantity is output according to the estimated value \hat{θ}(t) of the longitudinal motion model disturbance parameter, the estimated value \hat{σ}(t) of the external environment disturbance parameter, the input weighted estimated value \hat{ω}{circumflex over (()}t), the estimated value \hat{x}_{θ}_{ᵥ}(t) of the longitudinal motion state variable, the estimated error \tilde{x}_{θ}_{ᵥ}(t) of the longitudinal motion state variable, and the received desired attitude command signal.

A specific form of the L1 adaptive controller u_{ad}(t) of the designed longitudinal motion system is follows:

u_{ad}(s)=−kD(s)(\hat{η}(s)−k_{g}r(s))

Where u_{ad}(t) is a combination of the longitudinal periodic variable pitch input quantity and the collective pitch input quantity, u_{ad}(s) is the Laplace transform of u_{ad}(t), r(s) is the Laplace transform of a command input r(t), \hat{η}(s) is the Laplace transform of \hat{η}(t), and \hat{η}(t)=\hat{ω}(t)u_{ad}(t)+\hat{θ}^{T}x_{θ}_{ᵥ}(t)+\hat{σ}(t); k_{g} is a gain of the command input, k_{g}=−1/(c_{θ}_{ᵥ}^{T} Aₘ⁻¹b_{θ}_{ᵥ}), so that the system outputs a tracking command input signal that can be stabilized; D(s) is a strictly positive real transfer function,

$$D ( s ) = \frac{1}{s} ,$$

s expresses a s domain, and k is an adaptive feedback gain.

An appropriate adaptive feedback gain value is designed, which can ensure the asymptotic stability of a closed loop system. Therefore, an expression formula of a transfer function output by the longitudinal full-order state observer is solved as:

ŷ=c_{θ}_{ᵥ}^{T}(sI−Aₘ)⁻¹b_{θ}_{ᵥ}(\hat{ω}u+\hat{θ}x+\hat{σ})

Where ŷ is the transfer function, I is a unit matrix, s is an s domain, c_{θ}_{ᵥ}^{T} is a longitudinal system state output matrix, Aₘ is a longitudinal system state spatial feedback matrix, b_{θ}_{ᵥ} is a longitudinal system state input matrix, \hat{ω} is an input weighted estimated value, u is a longitudinal variable pitch input quantity, \hat{θ} is an estimated value of a longitudinal motion model disturbance parameter, x is a longitudinal motion state variable, and \hat{σ} is an estimated value of the external environment disturbance parameter.

When time tends to infinity, an output value may reach:

ŷ=−c_{θ}_{ᵥ}^{T}Aₘ⁻¹b_{θ}_{ᵥ}(\hat{ω}u+\hat{θ}x+\hat{σ})

In order to achieve ŷ=r, it may be solved that:

$$u = \frac{1}{\hat{ω}} ( - \frac{1}{- {c}_{{θ}_{v}}^{T} {A}_{m}^{- 1} {b}_{{θ}_{v}}} r - \hat{θ} x - \hat{σ} )$$

Therefore, the gain k_{g}=−1/(c_{θ}_{ᵥ}^{T}Aₘ⁻¹b_{θ}_{ᵥ}) may be solved.

D(s) is a strictly positive real transfer function, and

$$D ( s ) = \frac{1}{s}$$

design here.

The form of a low pass filter is set as:

$$C ( s ) = \frac{ω k}{s + ω k}$$

The design of the low pass filter C(s) needs to ensure C(0)=1, and when a s domain and a frequency domain are 0, an input of the low pass filter is equal to an output. The value k of the adaptive feedback gain directly affects the bandwidth of the low pass filter.

In order to ensure the asymptotic stability of the closed loop system, the design of k must satisfy an L1 small gain theorem of the closed loop system. Now, it is defined that:

L=max_{θ∈Θ}∥θ∥₁

H(s)=(sI−Aₘ)⁻¹b

G(s)=H(s)(1−C(s))

L, H(s), and G(s) are respectively intermediate variable transfer functions.

According to the L1 small gain theorem of the closed loop system, the designed adaptive feedback gain k needs to satisfy:

∥G(s)∥_{L1}L<1

G(s) is a transfer function, which is a description of the low pass filter and a system without a state feedback.

For the longitudinal motion model, the designed longitudinal motion control input quantity includes a collective pitch input quantity and a longitudinal periodic variable pitch input quantity. Therefore, a longitudinal linearization motion equation of the tandem rotor unmanned aerial vehicle is as follows:

$$[ \begin{matrix}\dot{{u}_{p}} \\ \dot{{w}_{p}} \\ \dot{{q}_{p}} \\ \dot{{θ}_{p}}\end{matrix} ] = [ \begin{matrix}\frac{{X}_{u}}{m} & \frac{{X}_{w}}{m} & ( \frac{{X}_{q}}{m} - {w}_{N} ) & - g cos {θ}_{N} \\ \frac{{Z}_{u}}{m} & \frac{{Z}_{w}}{m} & ( {u}_{N} + \frac{{Z}_{q}}{m} ) & - g sin {θ}_{N} \\ \frac{{M}_{u}}{{I}_{YY}} & \frac{{M}_{w}}{{I}_{YY}} & \frac{{M}_{q}}{{I}_{YY}} & 0 \\ 0 & 0 & 1 & 0\end{matrix} ] [ \begin{matrix}{u}_{P} \\ {w}_{P} \\ {q}_{P} \\ {θ}_{P}\end{matrix} ] + [ \begin{matrix}\frac{{X}_{{u}_{b}}}{m} & \frac{{X}_{{u}_{c}}}{m} \\ \frac{{Z}_{{u}_{b}}}{m} & \frac{{Z}_{{u}_{c}}}{m} \\ \frac{{M}_{{u}_{b}}}{{I}_{YY}} & \frac{{M}_{{u}_{c}}}{{I}_{YY}} \\ 0 & 0\end{matrix} ] [ \begin{matrix}{u}_{b , P} \\ {u}_{c , P}\end{matrix} ]$$

Where

u_{P} is a forward speed, \dot{u}ₚ is a forward speed change rate, w_{P} is a vertical speed, \dot{w}_{P} is a vertical speed change rate, q_{P} is a pitch rate, \dot{q}ₚ is a pitch rate change rate, θ_{P} is a pitch angle, \dot{θ}_{P} is a pitch angle change rate, m is the mass of the tandem rotor unmanned aerial vehicle, Xᵤ is an aerodynamic derivative in a forward direction, X_{w} is an aerodynamic derivative in a vertical direction, X_{q} is an aerodynamic derivative of the pitch angle, w_{N} is a vertical speed reference quantity, g is a gravitational acceleration, θ_{N} is an aircraft pitch angle when longitudinal motion is trimmed, Zᵤ is a derivative of a vertical resultant force with respect to the forward speed, Z_{w} is a derivative of the vertical resultant force with respect to the vertical speed, u_{N} is an aircraft forward speed when the longitudinal motion is trimmed, Z_{q} is a derivative of the vertical resultant force with respect to the pitch rate, Mᵤ is an aerodynamic derivative of a pitch moment with respect to the forward speed, M_{q} is an aerodynamic derivative of the pitch moment with respect to the vertical speed, M_{q} is an aerodynamic derivative of the pitch moment with respect to the pitch rate, I_{YY} is a Y-axis rotational inertia of a body axis system, Xᵤ_{_{b}} is a derivative of a forward resultant force with respect to a longitudinal variable pitch control quantity, Zᵤ_{_{b}} is a derivative of the vertical resultant force with respect to the longitudinal variable pitch control quantity, Zᵤ_{_{c}} is a derivative of the vertical resultant force with respect to the collective pitch control quantity, Mᵤ_{_{b}} is a derivative of the pitch moment with respect to the longitudinal variable pitch control quantity, Mᵤ_{_{c}} is a derivative of the pitch moment with respect to the collective pitch control quantity, u_{b,P} is a longitudinal variable pitch control quantity, and U_{c,P} is a collective pitch control quantity.

Further, a lateral linearization model of the tandem rotor unmanned aerial vehicle is expressed as:

\dot{x}θᵥ₁(t)=A_{θ}_{ᵥ₁}x_{θ}_{ᵥ₁}(t)+b_{θ}_{ᵥ₁}(ω₁(t)u₁(t)+θ₁^{T}(t)x_{θ}_{ᵥ₁}(t)+σ₁(t))

y_{θ}_{ᵥ₁}(t)=c_{θ}_{ᵥ₁}^{T}x_{θ}_{ᵥ₁}(t)

In the formula, x_{θ}_{ᵥ₁}(t) is a lateral motion state variable. The lateral motion state variable includes: a transverse roll rate, a transverse roll angle, a yaw rate, and a side speed. \dot{x}_{θ}_{ᵥ₁}(t) is a change rate of the lateral motion state variable, y_{θ}_{ᵥ₁}(t) is a yaw attitude angle output quantity, A_{θ}_{ᵥ₁} is a lateral system state spatial matrix, b_{θ}_{ᵥ₁} is a lateral system state input matrix, and ω₁(t) is a weight of a lateral input and is used for compensating an error of a system input matrix; u₁(t) is a lateral variable pitch input quantity, θ₁(t) is a lateral motion model disturbance parameter, that is, a system error of a lateral motion model, θ₁^{T}(t) is a transpose of θ₁(t), σ₁(t) is a lateral external environment disturbance parameter, that is, an influence error of the rotor unmanned aerial vehicle caused by external environment factors, C_{θ}_{ᵥ₁}^{T} is a lateral system state output matrix, and t is a time parameter.

Specifically, x_{θ}_{ᵥ₁}(t) is a column vector of 1×4, and θ₁(t) is a weighted parameter row vector of 1×4.

It is necessary to assume that the parameters in the model satisfy the following conditions:

Assumption 1: Parameters θ₁(t) and σ₁(t) satisfy:

θ₁(t)∈Θ,|σ₁(t)|≤Δ₀,∀t≥0

Where Θ is a known convex set, Δ₀∈R⁺.

Assumption 2: parameters θ₁(t) and σ₁(t) are continuously differentiable and uniformly bounded: ∥\dot{θ}₁(t)∥≤d_{θ}<∞,|\dot{σ}₁1(t)|≤d_{σ}<∞, ∀t≥0

Assumption 3: the weighted parameter φ₁∈R satisfies:

ω₁∈Ω₀∈[ω₁ ωᵤ].

For the lateral linearization model of the present disclosure, all assumptions above can be satisfied to ensure the reliability of the model.

For the lateral linearization model, an indicator function related to the lateral motion state variable and the lateral motion control input quantity is fit:

J₁=∫(x₁^{T}Q₁x₁+u₁^{T}R₁u₁)dt

J₁ is the indicator function, x₁ is an error quantity matrix between a desired lateral motion state variable and a real lateral motion state variable, x₁^{T} is a transpose of x₁, U₁ is a yaw control quantity and a transverse periodic variable pitch input matrix, and u₁^{T} is a transpose of u₁; Q₁ is a lateral motion state variable weighted parameter matrix, R₁ is a weighted parameter matrix of the lateral motion control input quantity, u₁=−Kₘ₁x₁, specifically, Q₁ is a 4×4 weighted parameter matrix, R₁ is a 2×2 weighted parameter matrix, Kₘ₁ is a feedback gain matrix, and Q₁ and R₁ in the indicator function respectively realize the weighting of the longitudinal motion state variable and the longitudinal periodic variable pitch input quantity. Both matrix Q₁ and matrix R₁ are diagonal positive semi-definite matrixes, elements on a diagonal line of the matrix Q₁ directly affect the convergence rate of the corresponding lateral motion state variable, and elements on a diagonal line of the matrix R₁ directly affect the energy magnitude of the transverse periodic variable pitch input quantity. The higher the convergence rate of lateral motion state variable, the greater the energy of the transverse periodic variable pitch input quantity, and the higher the requirement on actuators such as a steering engine. The optimal control of the LQR is to select Q₁ and R₁ in advance according to a real model case to find out an appropriate feedback gain matrix Kₘ₁, a feedback control input u₁=−Kₘ₁x₁ thereof optimizes the indicator function J₁; and the indicator function J₁ is optimal when reaching a minimum value, and the optimal represents the most energy-saving state of the model.

The solution of the feedback gain matrix Kₘ₁ in the linear quadratic regulation algorithm is:

Kₘ₁=R₁⁻¹b_{θ}_{ᵥ₁}^{T}P₁

Where R₁⁻¹ is an inverse of R, b_{θ}_{ᵥ₁}^{T} is a transpose of b_{θ}_{ᵥ₁}, P₁ is an intermediate parameter matrix, and P₁ is obtained by solving the following Riccati equation:

A_{θ}_{ᵥ₁}^{T}P₁+P₁A_{θ}_{ᵥ₁}−P₁b_{θ}_{ᵥ₁}R₁⁻¹b_{θ}_{ᵥ₁}P₁+Q₁=0

Where A_{θ}_{ᵥ₁}^{T} is a transpose of A_{θ}_{ᵥ₁}.

The lateral linearization model with a lateral motion state variable feedback is expressed as:

\dot{x}θᵥ₁(t)=Aₘ₁x_{θ}_{ᵥ₁}(t)+b_{θ}_{ᵥ₁}(ω₁(t)u₁(t)+θ₁^{T}(t)x_{θ}_{ᵥ₁}(t)+σ₁(t))

y_{θ}_{ᵥ₁}(t)=c_{θ}_{ᵥ₁}^{T}x_{θ}_{ᵥ₁}(t)

Aₘ₁=A_{θ}_{ᵥ₁}−b_{θ}_{ᵥ₁}Kₘ₁

Where Aₘ₁ is a lateral system state spatial feedback matrix.

Specifically, a specific expression formula of a lateral full-order state observer is as follows:

\hat{\dot{x}}θᵥ₁(t)=A_{θ}_{ᵥ₁}\hat{x}_{θ}_{ᵥ₁}(t)+b_{θ}_{ᵥ₁}(\hat{ω}₁(t)u₁(t)+\hat{θ}₁^{T}(t)x_{θ}_{ᵥ₁}(t)+\hat{σ}₁(t))

ŷ_{θ}_{ᵥ₁}(t)=c_{θ}_{ᵥ₁}^{T}\hat{x}_{θ}_{ᵥ₁}(t)

Where \hat{x}_{θ}_{ᵥ₁}(t) is an estimated value of the longitudinal motion state variable, \hat{\dot{x}}_{θ}_{ᵥ₁}(t) is change rate of the estimated value of the lateral motion state variable and is an input weighted estimated value, \hat{θ}₁^{T}(t) is an estimated value of θ₁_{_{T}} (t), and \hat{σ}₁(t) is an estimated value of the lateral external environment disturbance parameter; is an estimated value of a yaw attitude angle, and the lateral full-order state observer calculates the estimated value x_{θ}_{ᵥ₁}(t) of the lateral motion state variable.

Different from the above model expression formula, parameters ω₁(t), θ₁(t), and \hat{σ}₁(t) in the model are all estimated values calculated by the parameter adaptive law, and the observer calculates an estimated value x_{θ}_{ᵥ₁}(t) of the state variable accordingly. The deviation between the estimated state variable and a real state variable is used for the calculation of the parameter adaptive law.

An estimated error of the lateral motion state variable is as follows:

\tilde{\dot{x}}θᵥ₁(t)=A_{θ}_{ᵥ}\tilde{x}_{θ}_{ᵥ₁}(t)+b_{θ}_{ᵥ₁}(\tilde{ω}₁(t)u₁(t)+\tilde{θ}₁^{T}(t)x_{θ}_{ᵥ₁}(t)+\tilde{σ}₁(t))

\tilde{x}_{θ}_{ᵥ₁}(0)=0

\tilde{θ}₁(t)=\hat{θ}₁(t)−θ₁(t)

\tilde{x}_{θ}_{ᵥ₁}(t)=\hat{x}_{θ}_{ᵥ₁}(t)−x_{θ}_{ᵥ₁}(t)

\tilde{ω}₁(t)=\hat{ω}₁(t)−ω₁(t)

\tilde{σ}₁(t)=\hat{σ}₁(t)−σ₁(t)

Where \tilde{\dot{x}}_{θ}_{ᵥ₁}(t) is a change rate of the estimated error of the longitudinal motion state variable, \tilde{x}_{θ}_{ᵥ₁}(t) is the estimated error of the lateral motion state variable, \tilde{ω}₁(t) is a lateral input weighted estimated error, \hat{θ}₁(t) is an estimated value of the longitudinal motion model disturbance parameter, \tilde{θ}₁(t) is an estimated error of the lateral motion model disturbance parameter, and \tilde{σ}₁(t) is an estimated error of the external environment disturbance parameter. According to a relevant theorem of an L1 adaptive control theory, it can be proved that an estimated state error of the system is uniformly bounded.)

The parameter adaptive law is designed to obtain \hat{θ}₁(t), \hat{σ}₁(t) and ω₁(t) according to the estimated error of the lateral motion state variable; and an adaptive law calculation formula is as follows:

\hat{\dot{θ}}₁(t)=ΓProj(\hat{θ}₁(t),− [symbol] (t)Pb_{θ}_{ᵥ₁}x_{θ}_{ᵥ₁}(t)),\hat{θ}₁(0)=\hat{θ}₀

\hat{\dot{σ}}₁(t)=ΓProj(\hat{σ}₁(t),−\tilde{x}_{θ}_{ᵥ₁}^{T}(t)Pb_{θ}_{ᵥ₁}),\hat{σ}₁(0)=\hat{σ}₀

\hat{\dot{ω}}₁(t)=ΓProj(\hat{ω}₁(t),−\tilde{x}_{θ}_{ᵥ}^{T}(t)Pb_{θ}_{ᵥ₁}u_{ad}(t)),\hat{ω}₁(0)=\hat{ω}₀

Where \hat{θ}₁(t) is a change rate of the estimated value of the lateral motion model disturbance parameter, \hat{\dot{σ}}₁(t) is a change rate of the estimated value of the lateral external environment disturbance parameter, \hat{\dot{φ}}₁(t) is a change rate of a lateral input weighted estimated value, Γ∈R⁺ is an adaptive gain, and Proj(⋅) is a projection operator, which is specifically defined as follows:

$$Proj ( θ , y ) = \{ \begin{matrix}y , & f ( θ ) < 0 \\ y - \frac{∇ f ( θ )}{‖ ∇ f ( θ ) ‖} 〈 \frac{∇ f ( θ )}{‖ ∇ f ( θ ) ‖} , y 〉 & f ( θ ) \geq 0 , ∇ {f ( θ )}^{T} y > 0 \\ y , & f ( θ ) \geq 0 , ∇ {f ( θ )}^{T} y \leq 0\end{matrix}$$

Where ƒ:Rⁿ→R is a smooth convex function, which is specifically defined as follows:

$$f ( θ ) = \frac{( {ε}_{θ} + 1 ) {θ}^{T} θ - {θ}_{max}^{2}}{{ε}_{θ} {θ}_{max}^{2}}$$

Where θₘₐₓ is a boundary constraint of a vector θ; ε_{θ} is any small positive real number less than 1; and ∇ƒ(θ) is set as a gradient of ƒ(⋅) at θ.

P₁=P₁^{T} is substituted in the Lyapunov equation as follows:

Aₘ₁^{T}P₁+P₁Aₘ₁=−Q₁

For the solution of any Q₁=Q^{T}₁, Aₘ₁^{T} is a transpose of the lateral system state spatial feedback matrix. For any value of Q₁, the solution of the P₁ is unique. In combination with a lateral motion modeling case, it can be known that the input weighted parameter ω₁(t) and the lateral motion model disturbance parameter θ₁(t) are related to the weight, the rotational inertia, and the aerodynamic parameter of the tandem rotor unmanned aerial vehicle, and σ₁(t) is related to the disturbance of external environmental factors, such as wind.

The L1 adaptive controller of the lateral motion system is designed and the lateral motion control input quantity is output according to the estimated value \hat{θ}₁(t) of the lateral motion model disturbance parameter, the estimated value \hat{σ}₁(t) of the external environment disturbance parameter, the input weighted estimated value \hat{φ}₁(t), the estimated value \hat{x}_{θ}_{ᵥ₁}(t) of the lateral motion state variable, the estimated error \tilde{x}_{θ}_{ᵥ₁}(t) of the lateral motion state variable, and the received desired attitude command signal.

A specific form of the L1 adaptive controller u_{ad1}(t) of the designed lateral motion system is follows:

u_{ad1}(s)=−k₁D₁(s)(\hat{η}₁(s)−k_{g}_{₁}r₁(s))

Where u_{ad1}(t) is a combination of the transverse periodic variable pitch input quantity and the yaw control quantity, u_{ad1}(s) is the Laplace transform of u_{ad1}(t), r₁(s) is the Laplace transform of a command input r₁(t), \hat{η}₁(s) is the Laplace transform of \hat{η}₁(t), \hat{η}₁(t)=\hat{ω}₁(t)u_{ad}_{₁}(t)+\hat{θ}₁^{T}x_{θ}_{ᵥ₁}(t)+\hat{σ}₁(t); and k_{g}_{₁} is a gain of the command input,

k_{g}_{₁}=−1/(c_{θ}_{ᵥ₁}^{T}Aₘ₁⁻¹b_{θ}_{ᵥ₁})
so that the system outputs a tracking command input signal that can be stabilized; D₁(s) is a strictly positive real transfer function,

$${D}_{1} ( s ) = \frac{1}{s} ,$$

s expresses a s domain, and k₁ is an adaptive feedback gain.

An appropriate adaptive feedback gain value is designed, which can ensure the asymptotic stability of a closed loop system. Therefore, an expression formula of a transfer function output by the lateral full-order state observer is solved as:

ŷ₁=c_{θ}_{ᵥ₁}^{T}(sI−Aₘ₁)⁻¹b_{θ}_{ᵥ₁}(\hat{ω}₁u₁+\hat{θ}₁x₁+\hat{θ}₁x₁+\hat{σ}₁)

Where ŷ₁ is the transfer function, I is a unit matrix, s is an s domain, c_{θ}_{ᵥ₁}^{T} is a lateral system state output matrix, Aₘ₁ is a lateral system state spatial feedback matrix, b_{θ}_{ᵥ₁} is a lateral system state input matrix, \hat{ω}₁ is an input weighted estimated value, u₁ is a lateral variable pitch input quantity, \hat{θ}₁ is an estimated value of the lateral motion model disturbance parameter, x₁ is a lateral motion state variable, and \hat{σ}₁ is an estimated value of the lateral external environment disturbance parameter.

When time tends to infinity, an output value may reach:

ŷ₁=−c_{θ}_{ᵥ₁}^{T}Aₘ₁⁻¹b_{θ}_{ᵥ₁}(\hat{ω}₁u₁+\hat{θ}₁x₁+\hat{σ}₁)

In order to achieve ŷ₁=r₁, it may be solved that:

$${u}_{1} = \frac{1}{{\hat{ω}}_{1}} ( - \frac{1}{- {c}_{{θ}_{v 1}}^{T} {A}_{m 1}^{- 1} {b}_{{θ}_{v 1}}} {r}_{1} - {\hat{θ}}_{1} {x}_{1} - {\hat{σ}}_{1} )$$

Therefore, the gain k_{g1}=−1/(c_{θ}_{ᵥ₁}^{T}Aₘ₁⁻¹b_{θ}_{ᵥ₁}) may be solved.

D₁(s) is a strictly positive real transfer function, and

$${D}_{1} ( s ) = \frac{1}{s}$$

is selected to facilitate design here.

The form of a low pass filter is set as:

$${C}_{1} ( s ) = \frac{{ω}_{1} {k}_{1}}{s + {ω}_{1} {k}_{1}}$$

The design of the low pass filter C₁(s) needs to ensure C₁(0)=1, and when a s domain and a frequency domain are 0, an input of the low pass filter is equal to an output. The value k₁ of the adaptive feedback gain directly affects the bandwidth of the low pass filter.

In order to ensure the asymptotic stability of the closed loop system, the design of k₁ must satisfy an L1 small gain theorem of the closed loop system. Now, it is defined that:

L₁=max_{θ∈Θ}∥θ₁∥₁

H₁(s)=(sI−Aₘ₁)⁻¹b₁

G₁(s)=H₁(s)(1−C₁(s))

L₁, H₁(s), and G₁(s) are respectively intermediate variable transfer functions.

According to the L1 small gain theorem of the closed loop system, the designed adaptive feedback gain k needs to satisfy:

∥G₁(s)∥_{L1}<1

G₁(s) is a transfer function, which is a description of the low pass filter and a system without a state feedback.

For the lateral motion model, the designed lateral motion control input quantity includes a yaw control quantity and a transverse periodic variable pitch input quantity. Therefore, the lateral linearization motion equation of the tandem rotor unmanned aerial vehicle is as follows:

$$[ \begin{matrix}\begin{matrix}\begin{matrix}{\dot{p}}_{p} \\ {\dot{ϕ}}_{P}\end{matrix} \\ {\dot{r}}_{P}\end{matrix} \\ {\dot{v}}_{P}\end{matrix} ] = [ \begin{matrix}( \frac{{I}_{1} {L}_{p}}{{I}_{xx}} + \frac{{I}_{3} {N}_{p}}{{I}_{zz}} ) & 0 & ( \frac{{I}_{1} {L}_{r}}{{I}_{xx}} + \frac{{I}_{3} {N}_{r}}{{I}_{zz}} ) & ( \frac{{I}_{1} {L}_{v}}{{I}_{xx}} + \frac{{I}_{3} {N}_{v}}{{I}_{zz}} ) \\ 1 & 0 & tan {θ}_{N} & - g sin {θ}_{N} \\ \frac{{I}_{2} {L}_{p}}{{I}_{xx}} + \frac{{I}_{1} {N}_{p}}{{I}_{zz}} & 0 & ( \frac{{I}_{2} {L}_{r}}{{I}_{xx}} + \frac{{I}_{1} {N}_{r}}{{I}_{zz}} ) & ( \frac{{I}_{2} {L}_{v}}{{I}_{xx}} + \frac{{I}_{1} {N}_{v}}{{I}_{zz}} ) \\ ( {w}_{N} + \frac{{Y}_{p}}{m} ) & g cos {θ}_{N} & ( \frac{{Y}_{r}}{m} - {u}_{N} ) & \frac{{Y}_{v}}{m}\end{matrix} ] [ \begin{matrix}{p}_{P} \\ {ϕ}_{P} \\ {r}_{P} \\ {v}_{P}\end{matrix} ] + [ \begin{matrix}( \frac{{I}_{1} {L}_{{u}_{a}}}{{I}_{xx}} + \frac{{I}_{3} {N}_{{u}_{a}}}{{I}_{zz}} ) & ( \frac{{I}_{1} {L}_{{u}_{r}}}{{I}_{xx}} + \frac{{I}_{3} {N}_{{u}_{r}}}{{I}_{zz}} ) \\ 0 & 0 \\ ( \frac{{I}_{2} {L}_{{u}_{a}}}{{I}_{xx}} + \frac{{I}_{1} {N}_{{u}_{a}}}{{I}_{zz}} ) & ( \frac{{I}_{2} {L}_{{u}_{r}}}{{I}_{xx}} + \frac{{I}_{1} {N}_{{u}_{r}}}{{I}_{zz}} ) \\ {Y}_{{u}_{a}} & {Y}_{{u}_{r}}\end{matrix} ] [ \begin{matrix}{u}_{a , P} \\ {u}_{r , P}\end{matrix} ]$$

Where p_{P} is a transverse roll rate, \dot{p}_{P} is a change rate of the transverse roll rate, ϕ_{P} is a transverse roll angle, \dot{ϕ}_{P} is a change rate of the transverse angle, r_{P} is a yaw rate, \dot{r}_{P} is a change rate of the yaw rate, v_{P} is a side speed, \dot{v}_{P} is a change rate of the side speed, L_{P} is an aerodynamic derivative related to the roll rate and the roll angle, N_{P} is an aerodynamic derivative related to the roll rate and a yaw angle, Iₓₓ is an x-axis rotational inertia of a body axis system, I_{zz} is a z-axis rotational inertia of the body axis system, w_{N} is a vertical speed reference quantity, Yₚ is an aerodynamic derivative related to the roll rate and a side aerodynamic force, m is the mass of the tandem rotor unmanned aerial vehicle, g is a gravitational acceleration, θ_{N} is an aircraft pitch angle when longitudinal motion is trimmed, Lᵣ is an aerodynamic derivative related to the yaw rate and the roll angle, Nᵣ is an aerodynamic derivative related to the yaw rate and the yaw angle, Lᵥ is an aerodynamic derivative related to the side speed and the roll angle, Nᵥ is an aerodynamic derivative related to the side speed and the yaw angle, Yᵣ is an aerodynamic derivative related to the yaw rate and the side aerodynamic force, u_{N} is a forward speed reference quantity, Yᵥ is an aerodynamic derivative related to the side speed and the side aerodynamic force, Lᵤ_{ₐ} is a derivative of roll moment with respect to the transverse variable pitch control quantity, Nᵤ_{ₐ} is a derivative of yaw moment with respect to the transverse variable pitch control quantity, Lᵤ_{ᵣ} is a derivative of a roll moment with respect to a yaw control quantity, Nᵤ_{ᵣ} is a derivative of the yaw moment with respect to the yaw control quantity, u_{a,P} a transverse variable pitch control quantity, u_{r,P} is the yaw control quantity, Yᵤ_{ₐ} is a derivative of the side aerodynamic force with respect to the transverse variable pitch control quantity, and Yᵤ_{ᵣ} is a derivative of the side aerodynamic force with respect to the yaw control quantity.

The body axis system is that origin O is taken from the rotor unmanned aerial vehicle, and an ox axis of the body axis system is parallel to the axis of the rotor unmanned aerial vehicle. In the above formula,

$${I}_{1} = \frac{{I}_{XX} {I}_{ZZ}}{{I}_{XX} {I}_{ZZ} - {I}_{X Z}^{2}} ; {I}_{2} = \frac{{I}_{XX} {I}_{X Z}}{{I}_{XX} {I}_{Z Z} - {I}_{X Z}^{2}} ; {I}_{3} = \frac{{I}_{Z Z} {I}_{X Z}}{{I}_{XX} {I}_{Z Z} - {I}_{X Z}^{2}} ,$$

X, Y, and Z are resultant forces in the x, y, and z directions in the body axis system. The aerodynamic derivative and an operation derivative are recorded as:

$$B a = \frac{\partial B}{\partial a} , ;$$

a is a state quantity or a control input quantity, and B is a force or moment. u_{b,P} is a collective pitch input quantity, u_{c,P} is a longitudinal variable pitch control input quantity, u_{a,P} is a transverse variable pitch control input quantity, and U_{r,P} is a yaw control input quantity.

For the longitudinal motion model, the designed adaptive control input quantity is the collective pitch input quantity and the longitudinal periodic variable pitch input quantity; the collective pitch input quantity is an up-down lifting quantity; and the longitudinal periodic variable pitch input quantity is a front-rear tilt quantity. For the lateral motion model, the control input quantity is the yaw control quantity and the transverse periodic variable pitch input quantity. The transverse periodic variable pitch input quantity is a left-right tilt quantity, and the yaw control quantity is a left-right swinging quantity.

The present disclosure further discloses an attitude adjustment control method for a tandem rotor unmanned aerial vehicle. The method controls an attitude adjustment loop of the tandem rotor unmanned aerial vehicle by combining a linear quadratic adjustment algorithm and an L1 adaptive control algorithm to realize attitude adjustment of the tandem rotor unmanned aerial perform vehicle and ensure robust control of the attitude adjustment, which specifically includes the following steps.

In S1, a transverse and longitudinal linearization model of the tandem rotor unmanned aerial vehicle in different flight conditions is established, and a state feedback gain matrix is designed for the transverse and longitudinal linearization model through an LQR.

In S2, a full-order state observer is designed according to the transverse and longitudinal linearization model established in S1, and a measurement value of a sensor is combined to obtain an estimated value of a state variable and an estimated error of the state variable.

In S3, a parameter adaptive law is designed to obtain an estimated value of a disturbance parameter according to the estimated error of the state variable obtained in S2.

In S4, an L1 adaptive controller of a transverse and longitudinal motion system is designed to obtain a control input quantity according to the estimated value of the disturbance parameter obtained in S3, the estimated value of the state variable obtained in S2, the estimated error of the state variable, and a received desired attitude command signal.

In S5: the tandem rotor unmanned aerial vehicle is controlled to complete attitude adjustment according to the control input quantity.

Specifically, the transverse and longitudinal linearization model includes a lateral linearization model and a longitudinal linearization model. The control input quantity includes a lateral motion control input quantity and a longitudinal motion control input quantity. The L1 adaptive controller of the transverse and longitudinal motion system includes an L1 adaptive controller of a lateral motion system and an L1 adaptive controller of a longitudinal motion system. The L1 adaptive controller of the lateral motion system outputs the lateral motion control input quantity. The lateral motion control input quantity includes a transverse periodic variable pitch input quantity and a yaw control quantity. The L1 adaptive controller of the longitudinal motion system outputs the longitudinal motion control input quantity. The longitudinal motion control input quantity includes a collective pitch input quantity and a longitudinal periodic variable pitch input quantity. The state variable includes a transverse motion state variable and a longitudinal motion state variable. The full-order state observer includes a longitudinal full-order state observer and a lateral full-order state observer.

Specifically, after S1, the method further includes S11: a longitudinal linearization model of the tandem rotor unmanned aerial vehicle is expressed as:

\dot{x}θᵥ(t)=A_{θ}_{ᵥ}x_{θ}_{ᵥ}(t)+b_{θ}_{ᵥ}(ω(t)u(t)+θ^{T}(t)x_{θ}_{ᵥ}(t)+σ(t))

y_{θ}_{ᵥ}(t)=c_{θ}_{ᵥ}^{T}x_{θ}_{ᵥ}(t)

In the formula, x_{θ}_{ᵥ}(t) is a longitudinal motion state variable. The longitudinal motion state variable includes: a forward speed quantity, a vertical speed quantity, a pitch rate quantity, and a pitch angle quantity. \dot{x}_{θ}_{ᵥ}(t) is a change rate of the longitudinal motion state variable, y_{θ}_{ᵥ}(t) is a pitch attitude angle output quantity, A_{θ}_{ᵥ} is a longitudinal system state spatial matrix, b_{θ}_{ᵥ} is a longitudinal system state input matrix, and ω(t) is an input weight and is used for compensating an error of a system input matrix; u(t) is a longitudinal variable pitch input quantity, θ(t) is a longitudinal motion model disturbance parameter, that is, a system error of a longitudinal motion model, θ^{T}(t) is a transpose of θ(t), σ(t) is an external environment disturbance parameter, that is, an influence error of the rotor unmanned aerial vehicle caused by external environment factors, c_{θ}_{ᵥ}^{T} is a longitudinal system state output matrix, and t is a time parameter.

Specifically, x_{θ}_{ᵥ}(t) is a column vector of 1×4, and θ(t) is a weighted parameter row vector of 1×4.

It is necessary to assume that the parameters in the model satisfy the following conditions:

Assumption 1: parameters θ(t) and σ(t) satisfy: θ(t)∈Θ, |σ(t)|≤Δ₀,∀t≥0, and Θ is a known convex set, Δ₀∈R⁺.

Assumption 2: parameters θ(t) and σ(t) are continuously differentiable and uniformly bounded: ∥\dot{θ}(t)∥≤d_{θ}<∞,|\dot{σ}(t)|≤d_{σ}<∞, ∀t≥0.

Assumption 3: the weighted parameter ω∈R satisfies: ω∈Ω₀∈[ω₁ ωᵤ].

For the longitudinal linearization model of the present disclosure, all assumptions above can be satisfied to ensure the reliability of the model.

For the longitudinal linearization model, an indicator function related to the longitudinal motion state variable and the longitudinal motion control input quantity is fit:

J=∫(x^{T}Qx+u^{T}Ru)dt

J is the indicator function, x is an error quantity matrix between a desired longitudinal motion state variable and a real longitudinal motion state variable, x^{T} is a transpose of x, u is a collective pitch input quantity and a longitudinal periodic variable pitch input matrix, and u^{T} is a transpose of u; Q is a longitudinal motion state variable weighted parameter matrix, R is a weighted parameter matrix of the longitudinal motion control input quantity, u=−Kₘx, specifically, Q is a 4 λ4 weighted parameter matrix, R is a 2×2 weighted parameter matrix, Kₘ is a feedback gain matrix, and Q and R in the indicator function respectively realize the weighting of the longitudinal motion state variable and the longitudinal periodic variable pitch input quantity. Both matrix Q and matrix R are diagonal positive semi-definite matrixes, elements on a diagonal line of the matrix Q directly affect the convergence rate of the corresponding longitudinal motion state variable, and elements on a diagonal line of the matrix R directly affect the energy magnitude of the longitudinal periodic variable pitch input quantity. The higher the convergence rate of the longitudinal motion state variable, the greater the energy of the longitudinal periodic variable pitch input quantity, and the higher the requirement on actuators such as a steering engine. The optimal control of an LQR is to select Q and R in advance according to a real model case to find out an appropriate feedback gain matrix Kₘ, and a feedback control input u=−Kₘx thereof optimizes the indicator function J; and the indicator function J is optimal when reaching a minimum value, and the optimal represents the most energy-saving state of the model.

The solution of the feedback gain matrix Kₘ in the linear quadratic regulation algorithm is:

Kₘ=R⁻¹b_{θ}_{ᵥ}^{T}P

Where R⁻¹ is an inverse of R, b_{θ}_{ᵥ} is a transpose of v_{θ}_{ᵥ}, P is an intermediate parameter matrix, and P is obtained by solving the following Riccati equation:

A_{θ}_{ᵥ}^{T}P+PA_{θ}_{ᵥ}−Pb_{θ}_{ᵥ}R⁻¹b_{θ}_{ᵥ}P+Q=0

Where A_{θ}_{ᵥ}^{T} is a transpose of A_{θ}_{ᵥ}.

The longitudinal linearization model with a longitudinal motion state variable feedback is expressed as:

\dot{x}θᵥ(t)=Aₘx_{θ}_{ᵥ}(t)+b_{θ}_{ᵥ}(ω(t)u(t)+θ^{T}(t)x_{θ}_{ᵥ}(t)+σ(t))

y_{θ}_{ᵥ}(t)=c_{θ}_{ᵥ}^{T}x_{θ}_{ᵥ}(t)

Aₘ=A_{θ}_{ᵥ}−b_{θ}_{ᵥ}Kₘ

Where Aₘ is a longitudinal system state spatial feedback matrix.

After S2, the method further includes S21: a specific expression formula of the longitudinal full-order state observer is as follows:

\hat{\dot{x}}θᵥ(t)=A_{θ}_{ᵥ}\hat{x}_{θ}_{ᵥ}(t)+b_{θ}_{ᵥ}(\hat{ω}(t)u(t)+\hat{θ}^{T}(t)x_{θ}_{ᵥ}(t)+\hat{σ}(t))

ŷ_{θ}_{ᵥ}(t)=c_{θ}_{ᵥ}^{T}\hat{x}_{θ}_{ᵥ}(t)

Where \hat{x}_{θv}(t) is an estimated value of the longitudinal motion state variable, \hat{\dot{x}}_{θv}(t) is a change rate of the estimated value of the longitudinal motion state variable, \hat{ω}(t) is an input weighted estimated value, \hat{θ}_{T}(t) is an estimated value of θ^{T}(t), and \hat{σ}(t) is an estimated value of the external environment disturbance parameter; ŷ_{θv}(t) is an estimated value of a pitch attitude angle, and the estimated value \hat{x}_{θv}(t) of the longitudinal motion state variable is calculated.

Different from the above model expression formula, parameters \hat{ω}(t), \hat{θ}(t), and \hat{σ}(t) in the model are all estimated values calculated by the parameter adaptive law, and the longitudinal full-order state observer calculates and outputs an estimated value of the state variable. The deviation between the estimated value of the state variable and a real state variable is used for the calculation of the parameter adaptive law.

An estimated error of the longitudinal motion state variable is as follows:

\tilde{\dot{x}}θᵥ(t)=A_{θ}_{ᵥ}\tilde{x}_{θ}_{ᵥ}(t)+b_{θ}_{ᵥ}(\tilde{ω}(t)u(t)+\tilde{θ}^{T}(t)x_{θ}_{ᵥ}(t)+\tilde{σ}(t))

\tilde{x}_{θ}_{ᵥ}(0)=0

\tilde{θ}(t)=\hat{θ}(t)−θ(t)

\tilde{x}_{θ}_{ᵥ}(t)=\hat{x}_{θ}_{ᵥ}(t)−x_{θ}_{ᵥ}(t)

\tilde{ω}(t)=\hat{ω}(t)−ω(t)

\tilde{σ}(t)=\hat{σ}(t)−σ(t)

Where \tilde{\dot{x}}_{θ}_{ᵥ}(t) is a change rate of the estimated error of the longitudinal motion state variable, \tilde{x}_{θ}_{ᵥ} (t) is the estimated error of the longitudinal motion state variable, \tilde{ω}(t) is an input weighted estimated error, \hat{θ}(t) is an estimated value of the longitudinal motion model disturbance parameter, \tilde{θ}(t) is an estimated error of the longitudinal motion model disturbance parameter, and \tilde{σ}(t) is an estimated error of the external environment disturbance parameter. According to a relevant theorem of an L1 adaptive control theory, it can be proved that an estimated state error of the system is uniformly bounded.

Further, after S3, the method further includes S31:

The parameter adaptive law is designed to obtain \hat{θ}(t), \hat{σ}(t), and \hat{ω}(t) according to the estimated error of the longitudinal motion state variable; and an adaptive law calculation formula is as follows:

\hat{\dot{θ}}(t)=ΓProj(\hat{θ}(t),− [symbol] (t)Pb_{θ}_{ᵥ}x_{θ}_{ᵥ}(t)),\hat{θ}(0)=\hat{θ}₀

\hat{\dot{σ}}(t)=ΓProj(\hat{σ}(t),−\tilde{x}_{θ}_{ᵥ}^{T}(t)Pb_{θ}_{ᵥ}),\hat{σ}(0)=\hat{σ}₀

\hat{\dot{ω}}(t)=ΓProj(\hat{ω}(t),−\tilde{x}_{θ}_{ᵥ}^{T}(t)Pb_{θ}_{ᵥ}u_{ad}(t)),\hat{ω}(0)=\hat{ω}₀

Where \hat{\dot{θ}}(t) is a change rate of the estimated value of the longitudinal motion model disturbance parameter, \hat{\dot{σ}}(t) is a change rate of the estimated value of the external environment disturbance parameter, \hat{\dot{ω}}(t) is a change rate of the input weighted estimated value, Γ∈R⁺ is an adaptive gain, and Proj(⋅) is a projection operator, which is specifically defined as follows:

$$Proj ( θ , y ) = \{ \begin{matrix}y , & f ( θ ) < 0 \\ y - \frac{∇ f ( θ )}{‖ ∇ f ( θ ) ‖} 〈 \frac{∇ f ( θ )}{‖ ∇ f ( θ ) ‖} , y 〉 f ( θ ) , & f ( θ ) \geq 0 , ∇ {f ( θ )}^{T} y > 0 \\ y , & f ( θ ) \geq 0 , ∇ {f ( θ )}^{T} y \leq 0\end{matrix}$$

Where ƒ:Rⁿ→R is a smooth convex function, which is specifically defined as follows:

$$f ( θ ) = \frac{( {ε}_{θ} + 1 ) {θ}^{T} θ - {{θ}_{max}}^{2}}{{ε}_{θ} {{θ}_{max}}^{2}}$$

Where θₘₐₓ is a boundary constraint of a vector θ; ε_{θ} is any small positive real number less than 1; and ∇ƒ(θ) is set as a gradient of ƒ(⋅) at θ.

P=P^{T} is substituted in the Lyapunov equation as follows:

Aₘ^{T}P+PAₘ=−Q

For the solution of any Q=Q^{T}, Aₘ^{T} is a transpose of a longitudinal system state spatial feedback matrix. For any value of Q, the solution of the P is unique. In combination with a longitudinal motion modeling case, it may be known that the input weighted parameter ω(t) and a longitudinal motion model disturbance parameter θ(t) are related to the weight, the rotational inertia, and the aerodynamic parameter of the tandem rotor unmanned aerial vehicle, and σ(t) is related to the disturbance of external environmental factors, such as wind.

The L1 adaptive controller of the longitudinal motion system is designed and the longitudinal motion control input quantity is output according to the estimated value \hat{θ}(t) of the longitudinal motion model disturbance parameter, the estimated value \hat{σ}(t) of the external environment disturbance parameter, the input weighted estimated value \hat{ω}(t), the estimated value \hat{x}_{θ}_{ᵥ}(t) of the longitudinal motion state variable, the estimated error \tilde{x}_{θ}_{ᵥ}(t) of the longitudinal motion state variable, and the received desired attitude command signal.

Further, after S4, the method further includes S41:
a specific form of the L1 adaptive controller u_{ad}(t) ad of the designed longitudinal motion system is follows:

u_{ad}(s)=−kD(s)(\hat{η}(s)−k_{g}r(s))

Where u_{ad}(t) is a combination of the longitudinal periodic variable pitch input quantity and the collective pitch input quantity, u_{ad}(s) is the Laplace transform of u_{ad}(t) r(S) is the Laplace transform of a command input r(t), \hat{η}(S) is the Laplace transform of \hat{η}(t), and \hat{η}(t)=\hat{ω}(t)+\hat{θ}^{T}x_{θ}_{ᵥ}(t)+\hat{σ}(t); k_{g} is a gain of the command input, and k_{g}=−1/(c_{θ}_{ᵥ}^{T}Aₘ⁻¹b_{θ}_{ᵥ}), so that the system outputs a tracking command input signal that can be stabilized; and D(s) is a strictly positive real transfer function,

$$D ( s ) = \frac{1}{s} ,$$

s expresses a s domain, and k is an adaptive feedback gain.

An appropriate adaptive feedback gain value is designed, which can ensure the asymptotic stability of a closed loop system. Therefore, an expression formula of a transfer function output by the longitudinal full-order state observer is solved as:

ŷ=c_{θ}_{ᵥ}^{T}(sI−Aₘ)⁻¹b_{θ}_{ᵥ}(\hat{ω}u+\hat{θ}x+\hat{σ})

Where y̅ is the transfer function, I is a unit matrix, s is an s domain, c_{θ}_{ᵥ}^{T} is a longitudinal system state output matrix, Aₘ is a longitudinal system state spatial feedback matrix, b_{θ}_{ᵥ} is a longitudinal system state input matrix, \hat{ω} is an input weighted estimated value, u is a longitudinal variable pitch input quantity, \hat{θ} is an estimated value of a longitudinal motion model disturbance parameter, x is a longitudinal motion state variable, and \hat{σ} is an estimated value of the external environment disturbance parameter.

When time tends to infinity, an output value may reach:

ŷ=−c_{θ}_{ᵥ}^{T}Aₘ⁻¹b_{θ}_{ᵥ}(\hat{ω}u+\hat{θ}x+\hat{σ})

In order to achieve ŷ=r, it may be solved that:

$$u = \frac{1}{\hat{ω}} ( - \frac{1}{- {c}_{{θ}_{v}}^{T} {{A}_{m}}^{- 1} {b}_{{θ}_{v}}} r - \hat{θ} x - \hat{σ} )$$

Therefore, the gain k^{g}=−1/(c_{θ}_{ᵥ}^{T}Aₘ⁻¹b_{θ}_{ᵥ}) may be solved.

D(s) is a strictly positive real transfer function, and

$$D ( s ) = \frac{1}{s}$$

is selected to facilitate design here.

The form of a low pass filter is set as:

$$C ( s ) = \frac{ω k}{s + ω k}$$

The design of the low pass filter C(s) needs to ensure C(0)=1, and when a s domain and a frequency domain are 0, an input of the low pass filter is equal to an output. The value k of the adaptive feedback gain directly affects the bandwidth of the low pass filter.

In order to ensure the asymptotic stability of the closed loop system, the design of k must satisfy an L1 small gain theorem of the closed loop system. Now, it is defined that:

L=max_{θ∈Θ}∥θ∥₁

H(s)=(sI−Aₘ)⁻¹b

G(s)=H(s)(1−C(s))

L, H(s), and G(s) are respectively intermediate variable transfer functions.

According to the L1 small gain theorem of the closed loop system, the designed adaptive feedback gain k needs to satisfy:

∥G(s)∥_{L1}<1

G(s) is a transfer function, which is a description of the low pass filter and a system without a state feedback.

For the longitudinal motion model, the designed longitudinal motion control input quantity includes a collective pitch input quantity and a longitudinal periodic variable pitch input quantity. Therefore, a longitudinal linearization motion equation of the tandem rotor unmanned aerial vehicle is as follows:

$$[ \begin{matrix}{\dot{u}}_{p} \\ {\dot{w}}_{p} \\ {\dot{q}}_{p} \\ {\dot{θ}}_{p}\end{matrix} ] = [ \begin{matrix}\frac{{X}_{u}}{m} & \frac{{X}_{w}}{m} & ( \frac{{X}_{q}}{m} - {w}_{N} ) & - g cos {θ}_{N} \\ \frac{{Z}_{u}}{m} & \frac{{Z}_{w}}{m} & ( {u}_{N} + \frac{{Z}_{q}}{m} ) & - g sin {θ}_{N} \\ \frac{{M}_{u}}{{I}_{YY}} & \frac{{M}_{w}}{{I}_{YY}} & \frac{{M}_{q}}{{I}_{YY}} & 0 \\ 0 & 0 & 1 & 0\end{matrix} ] [ \begin{matrix}{u}_{P} \\ {w}_{P} \\ {q}_{P} \\ {θ}_{P}\end{matrix} ] + [ \begin{matrix}\frac{{X}_{{u}_{b}}}{m} & \frac{{X}_{{u}_{c}}}{m} \\ \frac{{Z}_{{u}_{b}}}{m} & \frac{{Z}_{{u}_{c}}}{m} \\ \frac{{M}_{{u}_{b}}}{{I}_{YY}} & \frac{{M}_{{u}_{c}}}{{I}_{YY}} \\ 0 & 0\end{matrix} ] [ \begin{matrix}{u}_{b , P} \\ {u}_{c , P}\end{matrix} ]$$

Where u_{P} is a forward speed, \dot{u}ₚ is a forward speed change rate, w_{P} is a vertical speed, \dot{w}_{P} is a vertical speed change rate, q_{P} is a pitch rate, \dot{q}_{P} is a pitch rate change rate, θ_{P} is a pitch angle, \dot{θ}_{P} is a pitch angle change rate, m is the mass of the tandem rotor unmanned aerial vehicle, Xᵤ is an aerodynamic derivative in a forward direction, X_{w} is an aerodynamic derivative in a vertical direction, X_{q} is an aerodynamic derivative of the pitch angle, w_{N} is a vertical speed reference quantity, g is a gravitational acceleration, θ_{N} is an aircraft pitch angle when longitudinal motion is trimmed, Zᵤ is a derivative of a vertical resultant force with respect to the forward speed, Z_{w} is a derivative of the vertical resultant force with respect to the vertical speed, u_{N} is an aircraft forward speed when the longitudinal motion is trimmed, Z_{q} is a derivative of the vertical resultant force with respect to the pitch rate, Mᵤ is an aerodynamic derivative of a pitch moment with respect to the forward speed, M_{w} is an aerodynamic derivative of the pitch moment with respect to the vertical speed, M_{q} is an aerodynamic derivative of the pitch moment with respect to the pitch rate, I_{YY} is a Y-axis rotational inertia of a body axis system, Xᵤ_{_{b}} is a derivative of a forward resultant force with respect to a longitudinal variable pitch control quantity, Zᵤ_{_{b}} is a derivative of the vertical resultant force with respect to the longitudinal variable pitch control quantity, Zᵤ_{_{c}} is a derivative of the vertical resultant force with respect to the collective pitch control quantity, Mᵤ_{_{b}} is a derivative of the pitch moment with respect to the longitudinal variable pitch control quantity, Mᵤ_{_{c}} is a derivative of the pitch moment with respect to the collective pitch control quantity, u_{b,P} is a longitudinal variable pitch control quantity, and u_{c,P} is a collective pitch control quantity.

Further, after S11, the method further includes S12:

the lateral linearization model of the tandem rotor unmanned aerial vehicle is expressed as:

\dot{x}θᵥ₁(t)=A_{θ}_{ᵥ₁}x_{θ}_{ᵥ₁}(t)+b_{θ}_{ᵥ₁}(ω₁(t)u₁(t)+θ₁^{T}(t)x_{θ}_{ᵥ₁}(t)+σ₁(t))

y_{θ}_{ᵥ₁}(t)=c_{θ}_{ᵥ₁}^{T}x_{θ}_{ᵥ₁}(t)

In the formula, x_{θ}_{ᵥ₁} (t) is a lateral motion state variable. The lateral motion state variable includes: a transverse roll rate, a transverse roll angle, a yaw rate, and a side speed. x̅_{θ}_{ᵥ₁} (t) is a change rate of the lateral motion state variable, \dot{y}_{θ}_{ᵥ₁} (t) is a yaw attitude angle output quantity, A_{θ}_{ᵥ₁} (t) is a lateral system state spatial matrix, b_{θ}_{ᵥ₁} (t) is a lateral system state input matrix, and ω₁(t) is a weight of a lateral input and is used for compensating an error of a system input matrix; u₁(t) is a lateral variable pitch input quantity, θ₁(t) is a lateral motion model disturbance parameter, that is, a system error of a lateral motion model, θ₁^{T}(t) is a transpose of θ₁(t), σ₁ (t) is a lateral external environment disturbance parameter, that is, an influence error of the rotor unmanned aerial vehicle caused by external environment factors c_{θ}_{ᵥ₁}^{T} is a lateral, system state output matrix, and t is a time parameter.

Specifically, X_{θ}_{ᵥ₁} (t) is a column vector of 1×4, and θ₁(t) is a weighted parameter row vector of 1×4.

It is necessary to assume that the parameters in the model satisfy the following conditions:

Assumption 1: Parameters θ₁(t) and σ₁(t) satisfy:

θ₁(t)∈Θ,∥σ₁(t)|≤Δ₀,∀t≥0

Where Θ is a known convex set, Δ₀∈R⁺.

Assumption 2: parameters θ₁(t) and σ₁(t) are continuously differentiable and uniformly bounded: ∥\dot{θ}₁(t)∥≤d_{θ}<∞,|\dot{σ}₁1(t)|≤d_{σ}<∞, ∀t≥0

Assumption 3: the weighted parameter ω₁∈R satisfies:

ω₁∈Ω₀∈[ω₁ ωᵤ].

For the lateral linearization model of the present disclosure, all assumptions above can be satisfied to ensure the reliability of the model.

For the lateral linearization model, an indicator function related to the lateral motion state variable and the lateral motion control input quantity is fit:
J₁=∫(x₁^{T}Q₁x₁+u₁^{T}R₁u₁)dt

J₁ is the indicator function, x₁ is an error quantity matrix between a desired lateral motion state variable and a real lateral motion state variable, x₁^{T} is a transpose of x₁, u₁ is a yaw control quantity and a transverse periodic variable pitch input matrix, and u₁^{T} is a transpose of u₁; Q₁ is a lateral motion state variable weighted parameter matrix, R₁ is a weighted parameter matrix of the lateral motion control input quantity, u₁=−Kₘ₁x₁, specifically, Q₁ is a 4×4 weighted parameter matrix, R₁ is a 2×2 weighted parameter matrix, Kₘ₁ is a feedback gain matrix, and Q₁ and R₁ in the indicator function respectively realize the weighting of the lateral motion state variable and the transverse periodic variable pitch input quantity. Both matrix Q₁ and matrix R₁ are diagonal positive semi-definite matrixes, elements on a diagonal line of the matrix Q₁ directly affect the convergence rate of the corresponding lateral motion state variable, and elements on a diagonal line of the matrix R₁ directly affect the energy magnitude of the transverse periodic variable pitch input quantity. The higher the convergence rate of lateral motion state variable, the greater the energy of the transverse periodic variable pitch input quantity, and the higher the requirement on actuators such as a steering engine. The optimal control of an LQR is to select Q₁ and R₁ in advance according to a real model to find out an appropriate feedback gain matrix Kₘ₁, and a feedback control input u₁=−Kₘ₁x₁ thereof optimizes the indicator function J₁; and the indicator function J₁ is optimal when reaching a minimum value, and the optimal represents the most energy-saving state of the model.

The solution of the feedback gain matrix Kₘ₁ in the linear quadratic regulation algorithm is:

Kₘ₁=R₁⁻¹b_{θ}_{ᵥ₁}^{T}P₁

Where R₁⁻¹ is an inverse of R, b_{θ}_{ᵥ₁}^{T} is a transpose of v_{θ}_{ᵥ₁}, P₁ is an intermediate parameter matrix, and P₁ is obtained by solving the following Riccati equation:

A_{θ}_{ᵥ₁}^{T}P₁+P₁A_{θ}_{ᵥ₁}−P₁b_{θ}_{ᵥ₁}R₁⁻¹b_{θ}_{ᵥ₁}P₁+Q₁=0

Where A_{θ}_{ᵥ₁}^{T} is a transpose of A_{θ}_{ᵥ₁}.

The lateral linearization model with a lateral motion state variable feedback is expressed as:

\dot{x}θᵥ₁(t)=Aₘ₁x_{θ}_{ᵥ₁}(t)+b_{θ}_{ᵥ₁}(ω₁(t)u₁(t)+θ₁^{T}(t)x_{θ}_{ᵥ₁}(t)+σ₁(t))

y_{θ}_{ᵥ₁}(t)=c_{θ}_{ᵥ₁}^{T}x_{θ}_{ᵥ₁}(t)

Aₘ₁=A_{θ}_{ᵥ₁}−b_{θ}_{ᵥ₁}Kₘ₁

Where Aₘ₁ is a lateral system state spatial feedback matrix.

Further, after S21, the method further includes S22:

a specific expression formula of a lateral full-order state observer is as follows:

\hat{\dot{x}}θᵥ₁(t)=A_{θ}_{ᵥ₁}\hat{x}_{θ}_{ᵥ₁}(t)+b_{θ}_{ᵥ₁}(\hat{ω}₁(t)u₁(t)+\hat{θ}₁^{T}(t)x_{θ}_{ᵥ₁}(t)+\hat{σ}₁(t))

ŷ_{θ}_{ᵥ₁}(t)=c_{θ}_{ᵥ₁}^{T}\hat{x}_{θ}_{ᵥ₁}(t)

Where \hat{x}_{θ}_{ᵥ₁}(t) is an estimated value of the lateral motion state variable, \hat{\dot{x}}_{θ}_{ᵥ₁}(t) is a change rate of the estimated value of the lateral motion state variable and is an input weighted estimated value, \hat{θ}₁(t) is an estimated value of θ₁^{T}(t), and \hat{σ}₁(t) is an estimated value of the lateral external environment disturbance parameter; ŷ_{θ}_{ᵥ₁}(t) is an estimated value of a yaw attitude angle, and the lateral full-order state observer calculates the estimated value x_{θ}_{ᵥ₁}(t) of the lateral motion state variable.

Different from the above model expression formula, parameters ω₁(t), θ₁(t), and \hat{σ}₁(t) in the model are all estimated values calculated by the parameter adaptive law, and the observer calculates an estimated value \hat{x}_{θ}_{ᵥ₁}(t) of the state variable accordingly. The deviation between the estimated state variable and a real state variable is used for the calculation of the parameter adaptive law.

An estimated error of the lateral motion state variable is as follows:

\tilde{\dot{x}}θᵥ₁(t)=A_{θ}_{ᵥ}\tilde{x}_{θ}_{ᵥ₁}(t)+b_{θ}_{ᵥ₁}(\tilde{ω}₁(t)u₁(t)+\tilde{θ}₁^{T}(t)x_{θ}_{ᵥ₁}(t)+\tilde{σ}₁(t))

\tilde{x}_{θ}_{ᵥ₁}(0)=0

\tilde{θ}₁(t)=\hat{θ}₁(t)−θ₁(t)

\tilde{x}_{θ}_{ᵥ₁}(t)=\hat{x}_{θ}_{ᵥ₁}(t)−x_{θ}_{ᵥ₁}(t)

\tilde{ω}₁(t)=\hat{ω}₁(t)−ω₁(t)

\tilde{σ}₁(t)=\hat{σ}₁(t)−σ₁(t)

Where \tilde{\dot{x}}_{θ}_{ᵥ₁}(t) is a change rate of the estimated error of the lateral motion state variable, \tilde{x}_{θ}_{ᵥ₁} (t) is the estimated error of the lateral motion state variable, ω₁(t) is a lateral input weighted estimated error, \hat{θ}₁(t) is an estimated value of a lateral motion model disturbance parameter, \tilde{θ}₁(t) is an estimated error of the lateral motion model disturbance parameter, and \tilde{σ}₁(t) is an estimated error of the lateral external environment disturbance parameter. According to a relevant theorem of an L1 adaptive control theory, it can be proved that an estimated state error of the system is uniformly bounded.

Further, after S31, the method further includes S32:
the parameter adaptive law is designed to obtain \hat{θ}₁(t), \hat{σ}₁(t) and ω₁(t) according to the estimated error of the lateral motion state variable; and an adaptive law calculation formula is as follows:

\hat{\dot{θ}}₁(t)=ΓProj(\hat{θ}₁(t),− [symbol] (t)Pb_{θ}_{ᵥ₁}x_{θ}_{ᵥ₁}(t)),\hat{θ}₁(0)=\hat{θ}₀

\hat{\dot{σ}}₁(t)=ΓProj(\hat{σ}₁(t),−\tilde{x}_{θ}_{ᵥ₁}^{T}(t)Pb_{θ}_{ᵥ₁}),\hat{σ}₁(0)=\hat{σ}₀

\hat{\dot{ω}}₁(t)=ΓProj(\hat{ω}₁(t),−\tilde{x}_{θ}_{ᵥ}^{T}(t)Pb_{θ}_{ᵥ₁}u_{ad}(t)),\hat{ω}₁(0)=\hat{ω}₀
wherein \hat{\dot{θ}}₁(t) is a change rate of the estimated value of the lateral motion model disturbance parameter, \hat{\dot{σ}}₁(t) is a change rate of the estimated value of the lateral external environment disturbance parameter, \hat{\dot{ω}}₁(t) is a change rate of the lateral input weighted; estimated value, Γ∈R⁺ is an adaptive gain, and Proj(⋅) is a projection operator, which is specifically defined as follows:

$$Proj ( θ , y ) = \{ \begin{matrix}y , & f ( θ ) < 0 \\ y - \frac{∇ f ( θ )}{‖ ∇ f ( θ ) ‖} 〈 \frac{∇ f ( θ )}{‖ ∇ f ( θ ) ‖} , y 〉 f ( θ ) , & f ( θ ) \geq 0 , ∇ {f ( θ )}^{T} y > 0 \\ y , & f ( θ ) \geq 0 , ∇ {f ( θ )}^{T} y \leq 0\end{matrix}$$

Where ƒ:Rⁿ→R is a smooth convex function, which is specifically defined as follows:

$$f ( θ ) = \frac{( {ε}_{θ} + 1 ) {θ}^{T} θ - {θ}_{max}^{2}}{{ε}_{θ} {θ}_{max}^{2}}$$

Where θₘₐₓ is a boundary constraint of a vector θ; ε_{θ} is any small positive real number less than 1; and ∇ƒ(θ) is set as a gradient of ƒ(⋅) at θ.

P₁=P₁^{T} is substituted in the Lyapunov equation as follows:

Aₘ₁^{T}P₁+P₁Aₘ₁=−Q₁

For the solution of any Q₁=Q^{T}₁, Aₘ₁^{T} is a transpose of the lateral system state spatial feedback matrix. For any value of Q₁, the solution of the P₁ is unique. In combination with a lateral motion modeling case, it can be known that the input weighted parameter ω₁(t) and the lateral motion model disturbance parameter θ₁(t) are related to the weight, the rotational inertia, and the aerodynamic parameter of the tandem rotor unmanned aerial vehicle, and σ₁(t) is related to the disturbance of external environmental factors, such as wind.

The L1 adaptive controller of the lateral motion system is designed and the lateral motion control input quantity is output according to the estimated value \hat{θ}₁(t) the lateral motion model disturbance parameter, the estimated value \hat{σ}₁(t) of the external environment disturbance parameter, the input weighted estimated value \hat{φ}₁(t), the estimated value \hat{x}_{θ}_{ᵥ₁}(t) of the lateral motion state variable, the estimated error \tilde{x}_{θ}_{ᵥ₁}(t) of the lateral motion state variable, and the received desired attitude command signal.

Further, after S41, the method further includes S42: a specific formula of the L1 adaptive controller of the lateral motion system is designed as follows:

u_{ad1}(s)=−k₁D₁(s)(\hat{η}₁(s)−k_{g1}r₁(s))

Where u_{ad1}(t) is a combination of the transverse periodic variable pitch input quantity and the yaw control quantity, u_{ad1}(s) is the Laplace transform of u_{ad1}(t), r₁(s) is the Laplace transform of a command input r₁(t), and \hat{η}₁(s) is the Laplace transform of \hat{η}₁(t), \hat{η}₁(t)=\hat{ω}₁(t)u_{ad}_{₁}(t)+\hat{θ}₁^{T}x_{θ}_{ᵥ₁}(t)+\hat{σ}₁(t); k_{g}_{₁} is a gain of the command input,

k_{g1}=−1/(c_{θ}_{ᵥ₁}^{T}Aₘ₁⁻¹b_{θ}_{ᵥ₁})

so that the system outputs a tracking command input signal that can be stabilized; D₁(S) is a strictly positive real transfer function,

$${D}_{1} ( s ) = \frac{1}{s} ,$$

S expresses a s domain, and k₁ is an adaptive feedback gain.

An appropriate adaptive feedback gain value is designed, which can ensure the asymptotic stability of a closed loop system. Therefore, an expression formula of a transfer function output by the lateral full-order state observer is solved as:

ŷ₁=c_{θ}_{ᵥ₁}^{T}(sI−Aₘ₁)⁻¹b_{θ}_{ᵥ₁}(\hat{ω}₁u₁+\hat{θ}₁x₁+\hat{σ}₁)

Where ŷ₁ is the transfer function, I is a unit matrix, s is an s domain, c_{θ}_{ᵥ₁}^{T} is a lateral system state output matrix, Aₘ₁ is a lateral system state spatial feedback matrix, b_{θ}_{ᵥ₁} is a lateral system state input matrix, \hat{ω}₁ is an input weighted estimated value, u₁ is a lateral variable pitch input quantity, \hat{θ}₁ is an estimated value of the lateral motion model disturbance parameter, x₁ is a lateral motion state variable, and \hat{σ}₁ is an estimated value of the lateral external environment disturbance parameter.

When time tends to infinity, an output value may reach:

ŷ₁=−c_{θ}_{ᵥ₁}^{T}Aₘ₁⁻¹b_{θ}_{ᵥ₁}(\hat{ω}₁u₁+\hat{θ}₁x₁+\hat{σ}₁)

In order to achieve ŷ₁=r₁, it may be solved that:

$${u}_{1} = \frac{1}{{\hat{ω}}_{1}} ( - \frac{1}{- {c}_{{θ}_{v 1}}^{T} {A}_{m 1}^{- 1} {b}_{{θ}_{v 1}}} {r}_{1} - {\hat{θ}}_{1} {x}_{1} - {\hat{σ}}_{1} )$$

Therefore, the gain k_{g1}=−1/(c_{θ}_{ᵥ₁}^{T}Aₘ₁⁻¹b₇₄ _{ᵥ₁}) may be solved.

D₁(s) is a strictly positive real transfer function, and

$${D}_{1} ( s ) = \frac{1}{s}$$

is selected to facilitate design here.

The form of a low pass filter is set as:

$${C}_{1} ( s ) = \frac{{ω}_{1} {k}_{1}}{s + {ω}_{1} {k}_{1}}$$

The design of the low pass filter C₁(s) needs to ensure C₁(0)=1, and when a s domain and a frequency domain are 0, an input of the low pass filter is equal to an output. The value k₁ of the adaptive feedback gain directly affects the bandwidth of the low pass filter.

In order to ensure the asymptotic stability of the closed loop system, the design of k₁ must satisfy an L1 small gain theorem of the closed loop system. Now, it is defined that:

L₁=max_{θ∈Θ}∥θ₁∥₁

H₁(s)=(sI−Aₘ₁)⁻¹b₁

G₁(s)=H₁(s)(1−C₁(s))

L₁, H₁(s), and G₁(s) are respectively intermediate variable transfer functions.

According to the L1 small gain theorem of the closed loop system, the designed adaptive feedback gain k needs to satisfy:

∥G₁(s)∥_{L1}L₁<1

G₁(s) is a transfer function, which is a description of the low pass filter and a system without a state feedback.

For the lateral motion model, the designed lateral motion control input quantity includes a yaw control quantity and a transverse periodic variable pitch input quantity. Therefore, the lateral linearization motion equation of the tandem rotor unmanned aerial vehicle is as follows:

$$[ \begin{matrix}{\dot{p}}_{p} \\ {\dot{ϕ}}_{P} \\ {\dot{r}}_{P} \\ {\dot{v}}_{P}\end{matrix} ] = [ \begin{matrix}( \frac{{I}_{1} {L}_{p}}{{I}_{xx}} + \frac{{I}_{3} {N}_{p}}{{I}_{zz}} ) & 0 & ( \frac{{I}_{1} {L}_{r}}{{I}_{xx}} + \frac{{I}_{3} {N}_{r}}{{I}_{zz}} ) & ( \frac{{I}_{1} {L}_{v}}{{I}_{xx}} + \frac{{I}_{3} {N}_{v}}{{I}_{zz}} ) \\ 1 & 0 & tan {θ}_{N} & - g sin {θ}_{N} \\ \frac{{I}_{2} {L}_{p}}{{I}_{xx}} + \frac{{I}_{1} {N}_{p}}{{I}_{zz}} & 0 & ( \frac{{I}_{2} {L}_{r}}{{I}_{xx}} + \frac{{I}_{1} {N}_{r}}{{I}_{zz}} ) & ( \frac{{I}_{2} {L}_{v}}{{I}_{xx}} + \frac{{I}_{1} {N}_{v}}{{I}_{zz}} ) \\ ( {w}_{N} + \frac{{Y}_{p}}{m} ) & g cos {θ}_{N} & ( \frac{{Y}_{r}}{m} - {u}_{N} ) & \frac{{Y}_{v}}{m}\end{matrix} ] [ \begin{matrix}{p}_{P} \\ {ϕ}_{P} \\ {r}_{P} \\ {v}_{P}\end{matrix} ] + [ \begin{matrix}( \frac{{I}_{1} {L}_{{u}_{a}}}{{I}_{xx}} + \frac{{I}_{3} {N}_{{u}_{a}}}{{I}_{zz}} ) & ( \frac{{I}_{1} {L}_{{u}_{r}}}{{I}_{xx}} + \frac{{I}_{3} {N}_{{u}_{r}}}{{I}_{zz}} ) \\ 0 & 0 \\ ( \frac{{I}_{2} {L}_{{u}_{a}}}{{I}_{xx}} + \frac{{I}_{1} {N}_{{u}_{a}}}{{I}_{zz}} ) & ( \frac{{l}_{2} {L}_{{u}_{γ}}}{{l}_{m}} + \frac{{l}_{1} {N}_{{u}_{γ}}}{{l}_{Z Z}} ) \\ {Y}_{{u}_{a}} & {Y}_{{u}_{r}}\end{matrix} ] [ \begin{matrix}{u}_{a , P} \\ {u}_{r , P}\end{matrix} ]$$

Where p_{P} is a transverse roll rate, \dot{p}_{P} is a change rate of the transverse roll rate, ϕ_{P} is a transverse roll angle, \dot{ϕ}_{P} is a change rate of the transverse roll angle, r_{P} is a yaw rate, \dot{r}_{P} is a change rate of the yaw rate, v_{P} is a side speed, \dot{v}_{P} is a change rate of a side speed, Lₚ is an aerodynamic derivative related to the roll rate and the roll angle, Nₚ is an aerodynamic derivative related to the roll rate and a yaw angle, Iₓₓ is an x-axis rotational inertia of a body axis system, I_{zz} is a z-axis rotational inertia of the body axis system, w_{N} is a vertical speed reference quantity, Yₚ is an aerodynamic derivative related to the roll rate and a side aerodynamic force, m is the mass of the tandem rotor unmanned aerial vehicle, g is a gravitational acceleration, θ_{N} is an aircraft pitch angle when longitudinal motion is trimmed, Lᵣ is an aerodynamic derivative related to the yaw rate and the roll angle, Nᵣ is an aerodynamic derivative related to the yaw rate and the yaw angle, Lᵥ is an aerodynamic derivative related to the side speed and the roll angle, Nᵥ is an aerodynamic derivative related to the side speed and the yaw angle, Yᵣ is an aerodynamic derivative related to the yaw rate and the side aerodynamic force, u_{N} is a forward speed reference value, Yᵥ is an aerodynamic derivative related to the side speed and the side aerodynamic force, Lᵤ_{ₐ} is a derivative of roll moment with respect to the transverse variable pitch control quantity, Nᵤ_{ₐ} is a derivative of yaw moment with respect to the transverse variable pitch control quantity, Lᵤ_{ᵣ} is a derivative of the roll moment with respect to a yaw control quantity, Nᵤ_{ᵣ} is a derivative of the yaw moment with respect to the yaw control quantity, U_{a,P} is a transverse variable pitch control quantity, N_{r,P} is the yaw control quantity, Yᵤ_{ₐ} is a derivative of the side aerodynamic force with respect to the transverse variable pitch control quantity, and Yᵤ_{ᵣ} is a derivative of the side aerodynamic force with respect to the yaw control quantity.

The body axis system is that origin O is taken from the rotor unmanned aerial vehicle, and an ox axis of the body axis system is parallel to the axis of the rotor unmanned aerial vehicle. In the above formula,

$${I}_{1} = \frac{{I}_{XX} {I}_{Z Z}}{{I}_{XX} {I}_{Z Z} - {I}_{X Z}^{2}} ; {I}_{2} = \frac{{I}_{XX} {I}_{X Z}}{{I}_{XX} {I}_{Z Z} - {I}_{X Z}^{2}} ; {I}_{3} = \frac{{I}_{Z Z} {I}_{X Z}}{{I}_{XX} {I}_{Z Z} - {I}_{X Z}^{2}} ,$$

X, Y, and Z are resultant forces in the x, y, and z directions in the body axis system. The aerodynamic derivative and an operation derivative are recorded as:

$$B a = \frac{\partial B}{\partial a} ;$$

a is a state quantity or a control input quantity, and B is a force or moment. u_{b,P} is a collective pitch input quantity, u_{c,P} is a longitudinal variable pitch control input quantity, u_{a,P} is a transverse variable pitch control input quantity, and u_{r,P} is a yaw control input quantity.

For the longitudinal motion model, the designed adaptive control input quantity is the collective pitch input quantity and the longitudinal periodic variable pitch input quantity; the collective pitch input quantity is an up-down lifting quantity; the longitudinal periodic variable pitch input quantity is a front-rear tilt quantity. For the lateral motion model, the control input quantity is the yaw control quantity and the transverse periodic variable pitch input quantity. The transverse periodic variable pitch input quantity is a left-right tilt quantity, and the yaw control quantity is a left-right swinging quantity.

The LQR is the linear quadratic regulation algorithm, called LQR for short. The LQR may obtain an optimal control law of a state linear feedback, which is easy to form closed-loop optimal control. The L1 adaptive control is a control consisting of a controlled object, a state predictor, an adaptive control law, a control law, and the like. The L1 adaptive controller, that is, the L1 adaptive control algorithm, is a fast and robust adaptive control. The algorithm is actually that a model is improved with reference to adaptive control. A low pass filter is added in a control law design link, which ensures the separation of the control law and an adaptive law design.

The controlled object: the controlled object is expressed in the form of state space, where ω, θ, and the like are parameter uncertainties.

The state predictor: a mathematical model is shown in the figure above, where x, ω, and the like are corresponding to estimated values in the controlled object. When time tends to infinity, the controlled object and the state predictor have consistent dynamic characteristics. The estimated deviation is stable in the sense of Lyapunov.

The adaptive law: an error between the state predictor and the controlled object is taken as a main input, which ensures that the error is stable in the sense of Lyapunov, and estimations of uncertainty parameters are obtained.

The control law: the control law includes two parts: 1, reconstruction for a reference input matched with the state predictor; and 2, a low pass filtering link.

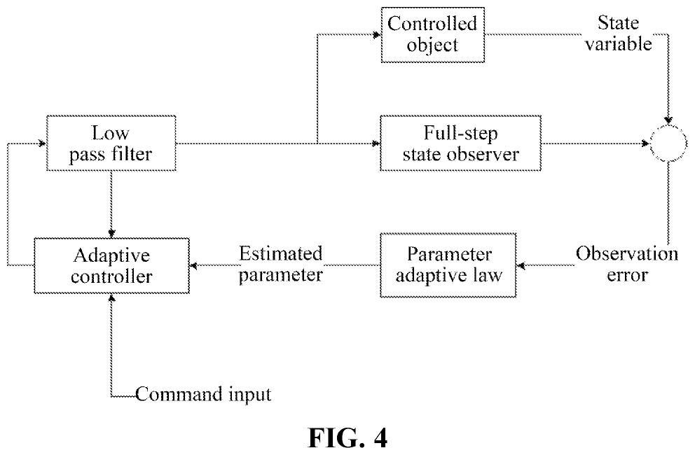

The control law of an attitude adjustment section of the attitude adjustment control method for the tandem rotor unmanned aerial vehicle of an embodiment of the present disclosure is specifically designed by using an L1 adaptive control structure method, and an overall closed loop control system is designed. FIG. 4 is a schematic diagram of an L1 adaptive control structure. An input design of the L1 adaptive controller includes a state feedback design and an adaptive control input design. The state feedback design is that a state feedback gain matrix reasonably allocates a system pole, so that an output of the system is stable, and meanwhile, input energy and an output change may reach the optimal. An adaptive control input is a core of the L1 adaptive controller. The output of the overall closed loop control system can meet desired dynamic characteristics by compensating the uncertainties of system parameters and external disturbances. The adaptive controller receives parameters instructing to input commands and estimations, and transmits a command control signal to a low pass filter for filtering. The filtered signal is sent to controlled objects, that is, a tandem rotor unmanned aerial vehicle and a state observer. The controlled object feeds back a state variable and a full-order state observer obtains an estimated state error of the system. The parameter adaptive law then calculates estimated values of related unknown parameters by means of a projection operation according to the estimated state error. The unknown parameters include transverse and longitudinal linearization model errors and an external environment disturbance parameter. The adaptive controller reconstructs an input through the estimated related parameters to compensate for the influence caused by model disturbance and uncertain change factors.

When the L1 adaptive control acts, the estimated state error of the control system is obtained by using the full-order state observer first, and then the parameter adaptive law calculates the estimated values of the related unknown parameters through the projection operator according to the estimated state error. The unknown parameters include transverse and longitudinal linearization model errors and an external environment disturbance parameter. The adaptive controller reconstructs the input through the estimated related parameters to compensate for the influence caused by system disturbance and uncertain change factors. The function of the low pass filter is to filter away a high-frequency signal from a control input signal. The design of a bandwidth of the low pass filter directly affects an amplitude value margin and a phase angle margin of system control, thereby affecting the robustness of controlling a model and a system.

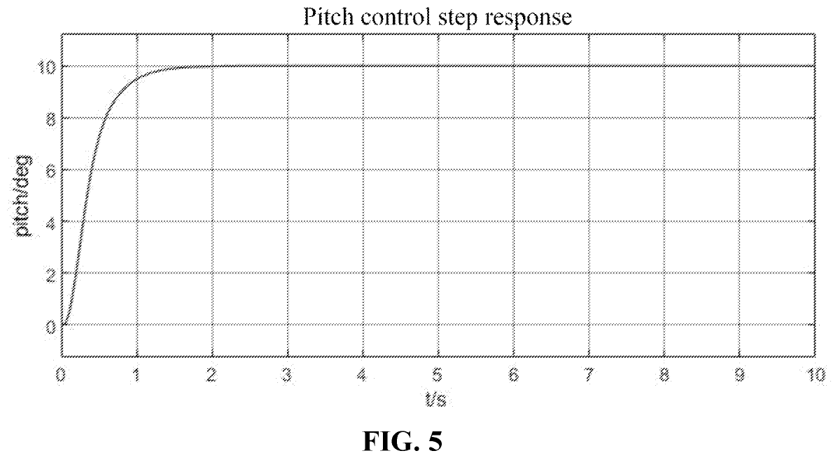

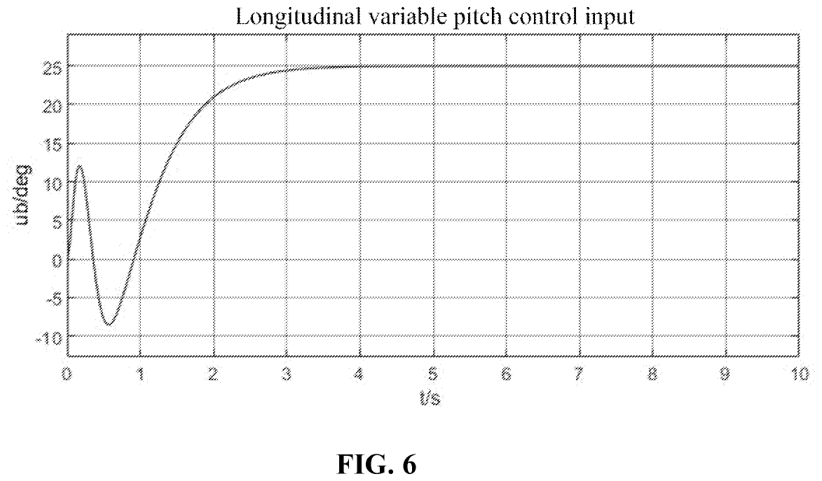

FIG. 5 is a simulation result diagram of a given 10° pitch angle step command signal. It can be seen from the figure that a dynamic transition time of the L1 adaptive controller is about 1.2 s, and an output does not have an overshoot. FIG. 6 is a control input change curve when a pitch angle tracking 10° step signal is controlled. It can be seen from FIG. 6 that the longitudinal periodic variable pitch input energy required for the design of the pitch attitude adjustment controller is relatively low, and the oscillation amplitude is about 10°.

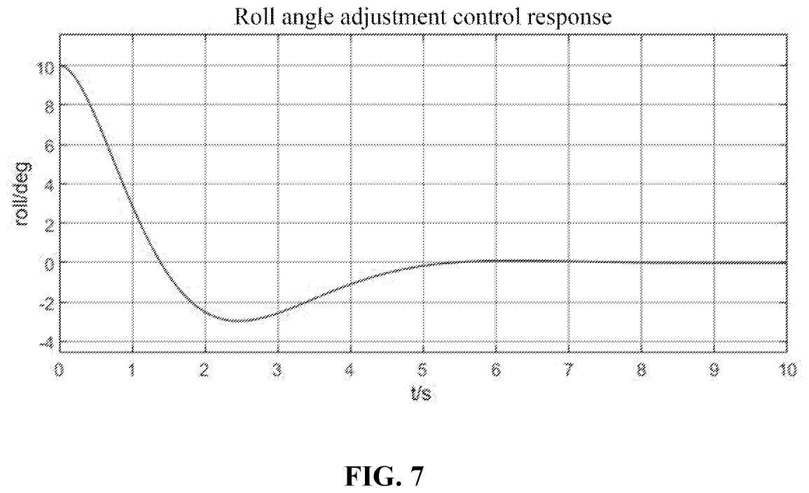

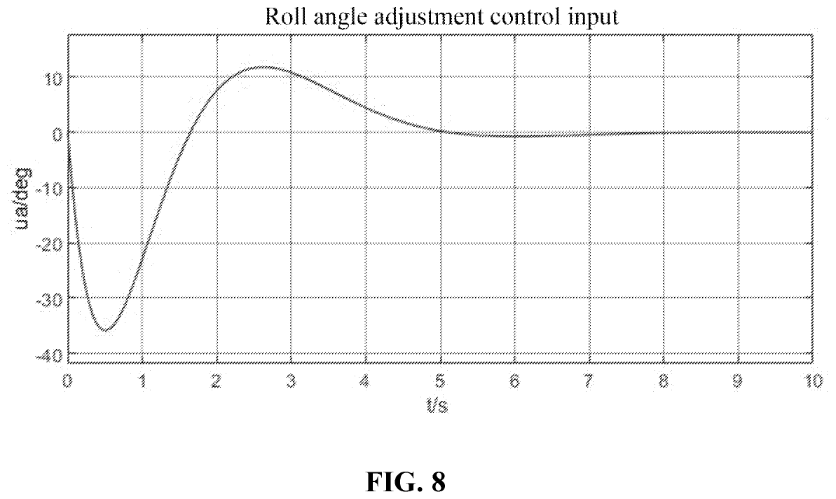

FIG. 7 is a simulation process that an attitude controller adjusts the roll angle to 0° when the tandem rotor unmanned aerial vehicle is set to be subjected to a 10° roll angle disturbance in an initial state. It can be seen from FIG. 7 that the attenuation adjustment speed of the roll angle is high, a steady-state establishment time is about 5 s, and a maximum value in a dynamic oscillation process does not exceeds 3°. FIG. 8 is a transverse variable pitch control input change curve in a process of adjusting a roll angle to 0°. It can be seen from FIG. 8 that the maximum amplitude value of an input of a roll controller does not exceed 35°, and the required control energy is within an acceptable range.

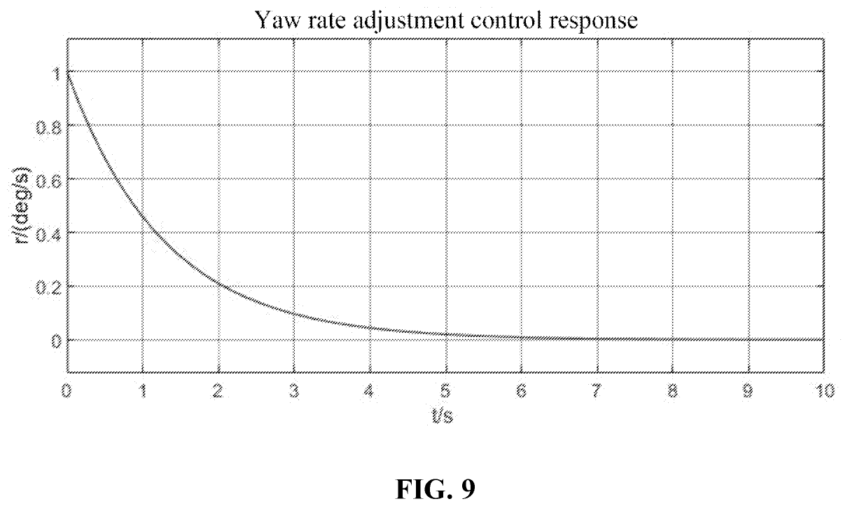

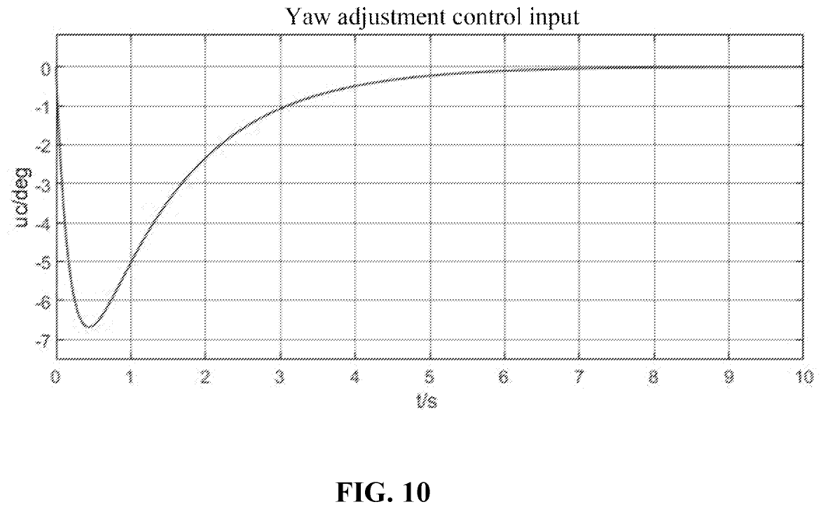

FIG. 9 is a simulation process that the attitude controller adjusts a yaw rate to 0° when the tandem rotor unmanned aerial vehicle is set to be subjected to a 1°/s yaw rate disturbance in an initial state. It can be seen from FIG. 9 that the steady-state establishment time of the yaw rate is about 6 s. There is no overshoot during the overall stable adjustment control process. FIG. 10 is a yaw control input change curve in a process of adjusting a yaw rate to 0. It can be seen from FIG. 10 that the maximum fluctuation amplitude value of an input of a yaw controller is 5°, and the required control energy is relatively low.

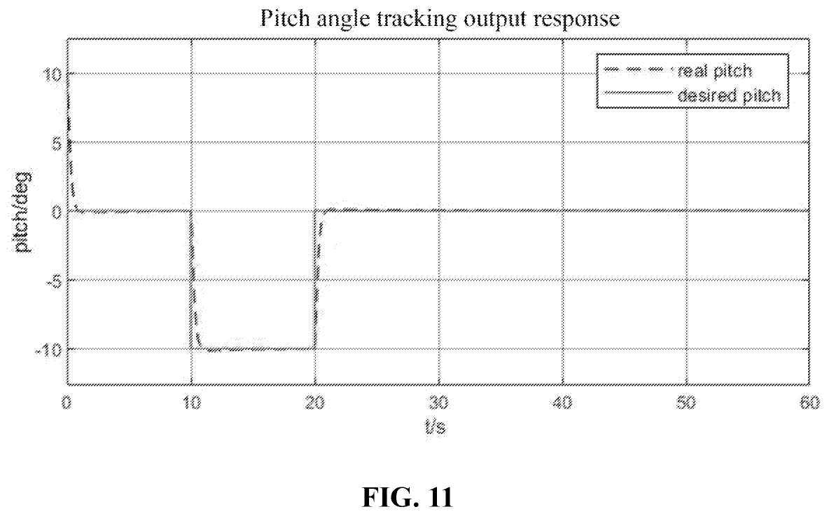

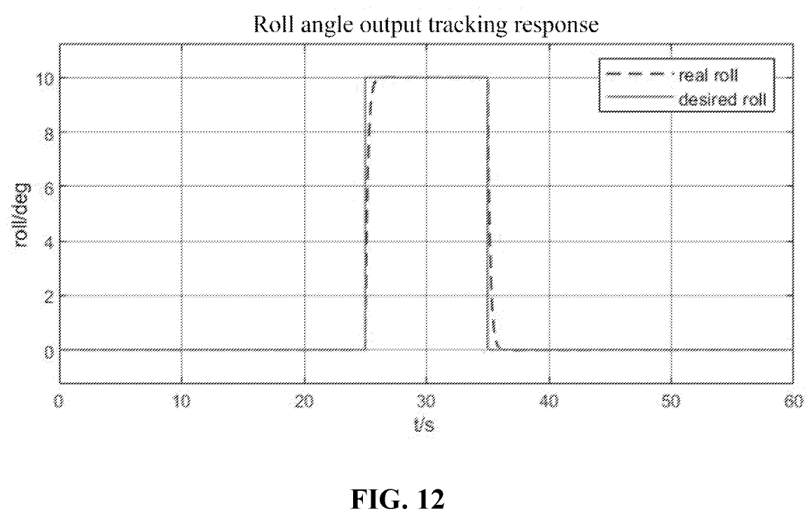

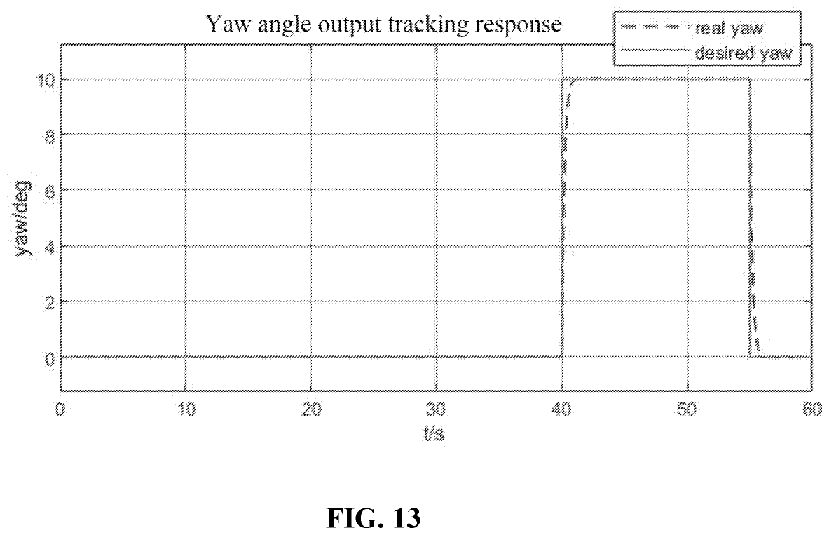

FIG. 11 is a pitch angle output tracking response after a rotor of the tandem rotor unmanned aerial vehicle is unfolded. It can be known from FIG. 11 that the pitch attitude response of the unmanned aerial vehicle is fast in a process of adjusting a pitch attitude of the unmanned aerial vehicle from 10° to −10°, oscillation and overshoot do not occur, and a dynamic process is good. FIG. 12 is a roll angle output tracking response of the tandem rotor unmanned aerial vehicle. It can be known from FIG. 12 that the roll attitude response of the unmanned aerial vehicle is fast in a process of controlling a roll attitude of the unmanned aerial vehicle from 0° to 10° and then from 10° to 0°, oscillation and overshoot do not occur, and a dynamic process is good. FIG. 13 is a yaw angle output tracking response of the tandem rotor unmanned aerial vehicle. It can be known from FIG. 13 that the yaw attitude response of the unmanned aerial vehicle is fast in a process of adjusting a yaw attitude of the unmanned aerial vehicle from 0° to 10° and then from 10° to 0°, oscillation and overshoot do not occur, and a dynamic process is good. It can be seen that, under the design of the LQR, an L1 adaptivity-based attitude adjustment controller can satisfy a condition of an input energy optimal design, and meanwhile, the fast and robust adjustment of the attitude of the unmanned aerial vehicle can be realized.

A working process of the present disclosure is that: when the tandem rotor unmanned aerial vehicle is launched, a motor provides power, a rotor is unfolded, and an attitude adjustment control command is input to start to adjust the attitude of the tandem rotor unmanned aerial vehicle. By the attitude adjustment control method for the tandem rotor unmanned aerial vehicle, a lateral motion control input quantity and a longitudinal motion control input quantity are generated, the lateral motion control input quantity and the longitudinal motion control input quantity are input into a flight control system, the flight control system receives the lateral motion control input quantity and the longitudinal motion control input quantity, and then the tandem rotor unmanned aerial vehicle is adjusted to a desired state by controlling the motor, the steering engine, and the automatic tilter.

The attitude adjustment control method for the tandem rotor unmanned aerial vehicle of the embodiment of the present disclosure has high control efficiency, and can adjust the tandem rotor unmanned aerial vehicle to an appropriate state within a shortest time. The fuel consumed in an adjustment process is the least, more fuel is saved, and an adjustment process is more stable and reliable.

In the descriptions of the specification, the descriptions made with reference to terms “an embodiment”, “some embodiments”, “example”, “specific example”, “some examples” or the like refer to that specific features, structures, materials or characteristics described in combination with the embodiment or the example are included in at least one embodiment or example of the present disclosure. In the present specification, the schematic representation of the above terms does not necessarily mean the same embodiment or example. Furthermore, the specific features, structures, materials, or characteristics described may be combined in a suitable manner in any one or more embodiments or examples.

It is not difficult for those skilled in the art to understand that the present disclosure includes any combination of the summary and detailed description of the embodiments of then description and various parts shown in the drawings. Due to limited space, various solutions formed by these combinations are not described one by one in order to make the description concise. Any modifications, equivalent replacements, improvements and the like made within the spirit and principle of the present disclosure shall fall within the scope of protection of the present disclosure.

What is claimed is:

1. A tandem rotor unmanned aerial vehicle, comprising a vehicle body, a flight control system, and a propulsion system, wherein the propulsion system comprises a front distributed propulsion system and a rear distributed propulsion system; the front distributed propulsion system is arranged at a front end of the vehicle body; the rear distributed propulsion system is arranged a rear end of the vehicle body; the front distributed propulsion system comprises rotor blades, a rotor nose, a main shaft, a speed reducer, a synchronizer, a motor, and a periodic variable pitch mechanism; the rotor blades are connected to the rotor nose; the rotor nose is connected to the main shaft; an output end of the motor is connected to the speed reducer; the speed reducer is connected to the synchronizer; the main shaft is connected to the speed reducer; the motor drives the main shaft to rotate through the speed reducer; the periodic variable pitch mechanism comprises a steering engine set and an automatic tilter; an output end of the steering engine set is connected to the automatic tilter; the automatic tilter is arranged on the main shaft in a sleeving manner; the automatic tilter is connected to the rotor nose; the automatic tilter changes tilt directions of the rotor blades through the rotor nose; the steering engine set comprises three steering engines; the flight control system controls the motor and the steering engine set to realize attitude adjustment of the tandem rotor unmanned aerial vehicle.

2. The tandem rotor unmanned aerial vehicle according to claim 1, wherein the rear distributed propulsion system has the same structure as the front distributed propulsion system.

3. The tandem rotor unmanned aerial vehicle according to claim 1, wherein the flight control system controls an attitude adjustment loop of the tandem rotor unmanned aerial vehicle by combining a linear quadratic regulation algorithm and an L1 adaptive control algorithm to realize the attitude adjustment of the tandem rotor unmanned aerial vehicle and ensure robust control of the attitude adjustment, which comprises:
establishing a transverse and longitudinal linearization model of the tandem rotor unmanned aerial vehicle in different flight conditions, and designing a state feedback gain matrix of the transverse and longitudinal linearization model by using the linear quadratic regulation algorithm;
designing a full-order state observer according to the transverse and longitudinal linearization model, and combining an observation state quantity value output by the full-order state observer and a measurement value of a sensor to obtain an estimated value of a state variable and an estimated error of the state variable;
designing a parameter adaptive law to obtain an estimated value of a disturbance parameter according to the estimated error of the state variable;
designing an L1 adaptive controller of a transverse and longitudinal motion system to obtain a control input quantity according to the estimated value of the disturbance parameter, the estimated value of the state variable, the estimated error of the state variable, and a received desired attitude command signal; and
controlling the tandem rotor unmanned aerial vehicle to complete the attitude adjustment according to the control input quantity.

4. The tandem rotor unmanned aerial vehicle according to claim 3, wherein the transverse and longitudinal linearization model comprises a lateral linearization model and a longitudinal linearization model; the control input quantity comprises a lateral motion control input quantity and a longitudinal motion control input quantity; the L1 adaptive controller of the transverse and longitudinal motion system comprises an L1 adaptive controller of a lateral motion system and an L1 adaptive controller of a longitudinal motion system; the L1 adaptive controller of the lateral motion system outputs the lateral motion control input quantity; the lateral motion control input quantity comprises a transverse periodic variable pitch input quantity and a yaw control quantity; the L1 adaptive controller of the longitudinal motion system outputs the longitudinal motion control input quantity; the longitudinal motion control input quantity comprises a collective pitch input quantity and a longitudinal periodic variable pitch input quantity; the state variable comprises a transverse motion state variable and a longitudinal motion state variable; and the full-order state observer comprises a longitudinal full-order state observer and a lateral full-order state observer.

5. The tandem rotor unmanned aerial vehicle according to claim 4, wherein the longitudinal linearization model of the tandem rotor unmanned aerial vehicle is expressed as:
\dot{x}θᵥ(t)=A_{θ}_{ᵥ}x_{θ}_{ᵥ}(t)+b_{θ}_{ᵥ}(ω(t)u(t)+θ^{T}(t)x_{θ}_{ᵥ}(t)+σ(t))
y_{θ}_{ᵥ}(t)=c_{θ}_{ᵥ}^{T}x_{θ}_{ᵥ}(t)
in the formula, x_{θ}_{ᵥ}(t) is the longitudinal motion state variable, \dot{x}_{θ}_{ᵥ}(t) is a change rate of the longitudinal motion state variable, y_{θ}_{ᵥ}(t) is a pitch attitude angle output quantity, A_{θ}_{ᵥ} is a longitudinal system state spatial matrix, b_{θ}_{ᵥ} is a longitudinal system state input matrix, ω(t) is an input weight and is used for compensating an error of a system input matrix; u(t) is a longitudinal variable pitch input quantity, θ(t) is a longitudinal motion model disturbance parameter, θ^{T}(t) is a transpose of θ(t) σ(t) is an external environment disturbance parameter, c_{θ}_{ᵥ}^{T} is a longitudinal system state output matrix, and t is a time parameter;
for the longitudinal linearization model, an indicator function related to the longitudinal motion state variable and the longitudinal motion control input quantity is fit:
J=∫(x^{T}Qx+u^{T}Ru)dt
J is the indicator function, x is an error quantity matrix between a desired longitudinal motion state variable and a real longitudinal motion state variable, x^{T} is a transpose of x, u is a collective pitch input quantity and a longitudinal periodic variable pitch input matrix, u^{T} is a transpose of u; Q is a longitudinal motion state variable weighted parameter matrix, R is a weighted parameter matrix of the longitudinal motion control input quantity, u=Kₘx, Kₘ is a feedback gain matrix, and the solution of the feedback gain matrix Kₘ in the linear quadratic regulation algorithm is:
Kₘ=R⁻¹b_{θ}_{ᵥ}^{T}P
wherein R⁻¹ is an inverse of R, b_{θ}_{ᵥ}^{T} is a transpose of b_{θ}_{ᵥ}, P is an intermediate parameter matrix, and P is obtained by solving the following Riccati equation:
A_{θ}_{ᵥ}^{T}P+PA_{θ}_{ᵥ}−Pb_{θ}_{ᵥ}R⁻¹b_{θ}_{ᵥ}P+Q=0
wherein A_{θ}_{ᵥ}^{T} is a transpose of A_{θ}_{ᵥ};
the longitudinal linearization model with a longitudinal motion state variable feedback is expressed as:
\dot{x}θᵥ(t)=Aₘx_{θ}_{ᵥ}(t)+b_{θ}_{ᵥ}(ω(t)u(t)+θ^{T}(t)x_{θ}_{ᵥ}(t)+σ(t))
y_{θ}_{ᵥ}(t)=c_{θ}_{ᵥ}^{T}x_{θ}_{ᵥ}(t)
Aₘ=A_{θ}_{ᵥ}−b_{θ}_{ᵥ}Kₘ
wherein Aₘ is a longitudinal system state spatial feedback matrix.

6. The tandem rotor unmanned aerial vehicle according to claim 5, wherein a specific expression formula of the longitudinal full-order state observer is as follows:
\hat{\dot{x}}θᵥ(t)=A_{θ}_{ᵥ}\hat{x}_{θ}_{ᵥ}(t)+b_{θ}_{ᵥ}(\hat{ω}(t)u(t)+\hat{θ}^{T}(t)x_{θ}_{ᵥ}(t)+\hat{σ}(t))
ŷ_{θ}_{ᵥ}(t)=c_{θ}_{ᵥ}^{T}\hat{x}_{θ}_{ᵥ}(t)
wherein \hat{x}_{θ}_{ᵥ}(t) is an estimated value of the longitudinal motion state variable, \hat{\dot{x}}_{θ}_{ᵥ}(t) is a change rate of the estimated value of the longitudinal motion state variable, \hat{ω}(t) is an input weighted estimated value, \hat{θ}^{T}(t) is an estimated value of θ^{T}(t), \hat{σ}(t) is an estimated value of the external environment disturbance parameter; ŷ_{θ}_{ᵥ}(t) is an estimated value of a pitch attitude angle, and the estimated value \hat{x}_{θ}_{ᵥ}(t) of the longitudinal motion state variable is calculated;
an estimated error of the longitudinal motion state variable is as follows:
\tilde{\dot{x}}θᵥ(t)=A_{θ}_{ᵥ}\tilde{x}_{θ}_{ᵥ}(t)+b_{θ}_{ᵥ}(\tilde{ω}(t)u(t)+\tilde{θ}^{T}(t)x_{θ}_{ᵥ}(t)+\tilde{σ}(t))
\tilde{x}_{θ}_{ᵥ}(0)=0
\tilde{θ}(t)=\hat{θ}(t)−θ(t)
\tilde{x}_{θ}_{ᵥ}(t)=\hat{x}_{θ}_{ᵥ}(t)−x_{θ}_{ᵥ}(t)
\tilde{ω}(t)=\hat{ω}(t)−ω(t)
\tilde{σ}(t)=\hat{σ}(t)−σ(t)
wherein \tilde{\dot{x}}_{θ}_{ᵥ}(t) is a change rate of the estimated error of the longitudinal motion state variable, \tilde{x}_{θ}_{ᵥ} (t) is the estimated error of the longitudinal motion state variable, \tilde{ω}(t) is an input weighted estimated error, \hat{θ}(t) is an estimated value of the longitudinal motion model disturbance parameter, \tilde{θ}(t) is an estimated error of the longitudinal motion model disturbance parameter, and \tilde{σ}(t) is an estimated error of the external environment disturbance parameter;
a parameter adaptive law is designed to obtain \hat{θ}(t), \hat{σ}(t), and \hat{ω}(t) according to the estimated error of the longitudinal motion state variable; and an adaptive law calculation formula is as follows:
\hat{\dot{θ}}(t)=ΓProj(\hat{θ}(t),−\tilde{x}_{θ}_{ᵥ}^{T}(t)Pb_{θ}_{ᵥ}x_{θ}_{ᵥ}(t))
\hat{\dot{σ}}(t)=ΓProj(\hat{σ}(t),−\tilde{x}_{θ}_{ᵥ}^{T}(t)Pb_{θ}_{ᵥ}),\hat{σ}(0)=\hat{σ}₀
\hat{\dot{ω}}(t)=ΓProj(\hat{ω}(t),−\tilde{x}_{θ}_{ᵥ}^{T}(t)Pb_{θ}_{ᵥ}u_{ad}(t)),\hat{ω}(0)=\hat{ω}₀
wherein \hat{\dot{θ}}(t) is a change rate of the estimated value of the longitudinal motion model disturbance parameter, \hat{\dot{σ}}(t) is a change rate of the estimated value of the external environment disturbance parameter, and \hat{\dot{ω}}(t) is a change rate of the input weighted estimated value;
the L1 adaptive controller of the longitudinal motion system is designed and the longitudinal motion control input quantity is output according to the estimated value \hat{θ}(t) of the longitudinal motion model disturbance parameter, the estimated value \hat{σ}(t) of the external environment disturbance parameter, the input weighted estimated value \hat{ω}(t), the estimated value \hat{x}_{θ}_{ᵥ} (t) of the longitudinal motion state variable, the estimated error \tilde{x}_{θ}_{ᵥ}(t) of the longitudinal motion state variable, and the received desired attitude command signal;
a specific form of the designed L1 adaptive controller u_{ad}(t) is as follows:
u_{ad}(s)=−kD(s)(\hat{η}(s)−k_{g}r(s))
wherein u_{ad}(t) is a combination of the longitudinal periodic variable pitch input quantity and the collective pitch input quantity, u_{ad}(s) is the Laplace transform of u_{ad}(t), r(s) is the Laplace transform of a command input r(t), \hat{η}(s) is the Laplace transform of \hat{η}(t), \hat{η}(t)=\hat{ω}(t)u_{ad}(t)+\hat{θ}^{T}x_{θ}_{ᵥ}(t)+\hat{σ}(t); k_{g} is a gain of the command input, k_{g}=−1/(c_{θ}_{ᵥ}^{T}Aₘ⁻¹b_{θ}_{ᵥ}); and D(s) is a strictly positive real transfer function,
$$D ( s ) = \frac{1}{s} ,$$
s expresses a s domain, and k is an adaptive feedback gain.

7. An attitude adjustment control method for a tandem rotor unmanned aerial vehicle, wherein an attitude adjustment loop of the tandem rotor unmanned aerial vehicle according to claim 1 is controlled by combining a linear quadratic regulation algorithm and an L1 adaptive control algorithm to realize attitude adjustment of the tandem rotor unmanned aerial vehicle and ensure robust control of the attitude adjustment, which specifically comprises:
S1: establishing a transverse and longitudinal linearization model of the tandem rotor unmanned aerial vehicle according to claim 1 in different flight conditions, and designing a state feedback gain matrix for the transverse and longitudinal linearization model through a Linear Quadratic Regulator (LQR);
S2: designing a longitudinal full-order state observer according the transverse and longitudinal linearization model established in S1, and combining with a measurement value of a sensor to obtain an estimated value of a state variable and an estimated error of the state variable;
S3: designing a parameter adaptive law to obtain an estimated value of a disturbance parameter according to the estimated error of the state variable obtained in S2;
S4: designing an L1 adaptive controller of a transverse and longitudinal motion system to obtain a control input quantity according to the estimated value of the disturbance parameter obtained in S3, the estimated value of the state variable obtained in S2, the estimated error of the state variable, and a received desired attitude command signal; and
S5: controlling the tandem rotor unmanned aerial vehicle to complete attitude adjustment according to the control input quantity.

8. The attitude adjustment control method for a tandem rotor unmanned aerial vehicle according to claim 7, wherein the transverse and longitudinal linearization model comprises a lateral linearization model and a longitudinal linearization model; the control input quantity comprises a lateral motion control input quantity and a longitudinal motion control input quantity; the L1 adaptive controller of the transverse and longitudinal motion system comprises an L1 adaptive controller of a lateral motion system and an L1 adaptive controller of a longitudinal motion system; the L1 adaptive controller of the lateral motion system outputs the lateral motion control input quantity; the lateral motion control input quantity comprises a transverse periodic variable pitch input quantity and a yaw control quantity; the L1 adaptive controller of the longitudinal motion system outputs the longitudinal motion control input quantity; the longitudinal motion control input quantity comprises a collective pitch input quantity and a longitudinal periodic variable pitch input quantity; the state variable comprises a transverse motion state variable and a longitudinal motion state variable; and the full-order state observer comprises a longitudinal full-order state observer and a lateral full-order state observer.

9. The attitude adjustment control method for a tandem rotor unmanned aerial vehicle according to claim 8, after S1, further comprising:
S11: expressing the longitudinal linearization model of the tandem rotor unmanned aerial vehicle as:
\dot{x}θᵥ(t)=A_{θ}_{ᵥ}x_{θ}_{ᵥ}(t)+b_{θ}_{ᵥ}(ω(t)u(t)+θ^{T}(t)x_{θ}_{ᵥ}(t)+σ(t))
y_{θ}_{ᵥ}(t)=c_{θ}_{ᵥ}^{T}x_{θ}_{ᵥ}(t)
wherein in the formula, x_{θ}_{ᵥ}(t) is the longitudinal motion state variable, \dot{x}_{θ}_{ᵥ}(t) is a change rate of the longitudinal motion state variable, y_{θ}_{ᵥ}(t) is a pitch attitude angle output quantity, A_{θ}_{ᵥ} is a longitudinal system state spatial matrix, b_{θ}_{ᵥ} is a longitudinal system state input matrix, ω(t) is an input weight and is used for compensating an error of a system input matrix; u(t) is a longitudinal variable pitch input quantity, θ(t) is a longitudinal motion model disturbance parameter, θ^{T}(t) is a transpose of θ(t), σ(t) is an external environment disturbance parameter, c_{θ}_{ᵥ}^{T} is a longitudinal system state output matrix, and t is a time parameter;
for the longitudinal linearization model, an indicator function related to the longitudinal motion state variable and the longitudinal motion control input quantity is fit:
J=∫(x^{T}Qx+u^{T}Ru)dt
wherein J is the indicator function, x is an error quantity matrix between a desired longitudinal motion state variable and a real longitudinal motion state variable, x^{T} is a transpose of x, u is a collective pitch input quantity and a longitudinal periodic variable pitch input matrix, and u^{T} is a transpose of u; Q is a longitudinal motion state variable weighted parameter matrix, R is a weighted parameter matrix of the longitudinal motion control input quantity, u=−Kₘx, Kₘ is a feedback gain matrix, and the solution of the feedback gain matrix Kₘ in the linear quadratic regulation algorithm is:
Kₘ=R⁻¹b_{θ}_{ᵥ}^{T}P
wherein R⁻¹ an inverse of R, b_{θ}_{ᵥ}^{T} is a transpose of b_{θ}_{ᵥ}, P is an intermediate parameter matrix, and P is obtained by solving the following Riccati equation:
A_{θ}_{ᵥ}^{T}P+PA_{θ}_{ᵥ}−Pb_{θ}_{ᵥ}R⁻¹b_{θ}_{ᵥ}P+Q=0
wherein A_{θ}_{ᵥ}^{T} is a transpose of A_{θ}_{ᵥ};
the longitudinal linearization model with a longitudinal motion state variable feedback is expressed as:
\dot{x}θᵥ(t)=Aₘx_{θ}_{ᵥ}(t)+b_{θ}_{ᵥ}(ω(t)u(t)+θ^{T}(t)x_{θ}_{ᵥ}(t)+σ(t))
y_{θ}_{ᵥ}(t)=c_{θ}_{ᵥ}^{T}x_{θ}_{ᵥ}(t)
Aₘ=A_{θ}_{ᵥ}−b_{θ}_{ᵥ}Kₘ
wherein Aₘ is a longitudinal system state spatial feedback matrix.

10. The attitude adjustment control method for a tandem rotor unmanned aerial vehicle according to claim 9, after S2, further comprising S21: designing a specific expression formula of the longitudinal full-order state observer as follows:
\hat{\dot{x}}θᵥ(t)=A_{θ}_{ᵥ}\hat{x}_{θ}_{ᵥ}(t)+b_{θ}_{ᵥ}(\hat{ω}(t)u(t)+\hat{θ}^{T}(t)x_{θ}_{ᵥ}(t)+\hat{σ}(t))
ŷ_{θ}_{ᵥ}(t)=c_{θ}_{ᵥ}^{T}\hat{x}_{θ}_{ᵥ}(t)
wherein \hat{x}_{θ}_{ᵥ} (t) is an estimated value of the longitudinal motion state variable, \hat{\dot{x}}_{θ}_{ᵥ}(t) is a change rate of the estimated value of the longitudinal motion state variable, \hat{ω}(t) is an input weighted estimated value, \hat{θ}^{T}(t) is an estimated value of θ_{T}(t), \hat{σ}(t) is an estimated value of the external environment disturbance parameter; ŷ_{θ}_{ᵥ}(t) is an estimated value of a pitch attitude angle, and the estimated value \hat{x}_{θ}_{ᵥ}(t) v of the longitudinal motion state variable is calculated;
an estimated error of the longitudinal motion state variable is as follows:
\tilde{\dot{x}}θᵥ(t)=A_{θ}_{ᵥ}\tilde{x}_{θ}_{ᵥ}(t)+b_{θ}_{ᵥ}(\tilde{ω}(t)u(t)+\tilde{θ}^{T}(t)x_{θ}_{ᵥ}(t)+\tilde{σ}(t))
\tilde{x}_{θ}_{ᵥ}(0)=0
\tilde{θ}(t)=\hat{θ}(t)−θ(t)
\tilde{x}_{θ}_{ᵥ}(t)=\hat{x}_{θ}_{ᵥ}(t)−x_{θ}_{ᵥ}(t)
\tilde{ω}(t)=\hat{ω}(t)−ω(t)
\tilde{σ}(t)=\hat{σ}(t)−σ(t)
wherein \tilde{\dot{x}}_{θ}_{ᵥ}(t) is a change rate of the estimated error of the longitudinal motion state variable, \tilde{x}_{θ}_{ᵥ}(t) is the estimated error of the longitudinal motion state variable, \tilde{ω}(t) is an input weighted estimated error, \hat{θ}(t) is an estimated value of the longitudinal motion model disturbance parameter, \tilde{θ}(t) is an estimated error of the longitudinal motion model disturbance parameter, and \tilde{σ}(t) is an estimated error of the external environment disturbance parameter;
after S3, further comprising S31: designing the parameter adaptive law to obtain \hat{θ}(t) \hat{σ}(t) and \hat{ω}(t) according to the estimated error of the longitudinal motion state variable, wherein an adaptive law calculation formula is as follows:
\hat{\dot{θ}}(t)=ΓProj(\hat{θ}(t),− [symbol] (t)Pb_{θ}_{ᵥ}x_{θ}_{ᵥ}(t)),\hat{θ}(0)=\hat{θ}₀
\hat{\dot{σ}}(t)=ΓProj(\hat{σ}(t),−\tilde{x}_{θ}_{ᵥ}^{T}(t)Pb_{θ}_{ᵥ}),\hat{σ}(0)=\hat{σ}₀
\hat{\dot{ω}}(t)=ΓProj(\hat{ω}(t),−\tilde{x}_{θ}_{ᵥ}^{T}(t)Pb_{θ}_{ᵥ}u_{ad}(t)),\hat{ω}(0)=\hat{ω}₀
wherein \hat{\dot{θ}}(t) is a change rate of the estimated value of the longitudinal motion model disturbance parameter, \hat{\dot{σ}}(t) is a change rate of the estimated value of the external environment disturbance parameter, and \hat{\dot{ω}}(t) is a change rate of the input weighted estimated value;
the L1 adaptive controller of the longitudinal motion system is designed and the longitudinal motion control input quantity is output according to the estimated value \hat{θ}(t) of the longitudinal motion model disturbance parameter, the estimated value \hat{σ}(t) of the external environment disturbance parameter, the input weighted estimated value \hat{ω}(t), the estimated value \hat{x}_{θ}_{ᵥ}(t) of the longitudinal motion state variable, the estimated error \tilde{x}_{θ}_{ᵥ}(t) of the longitudinal motion state variable, and the received desired attitude command signal;
after S4, further comprising S41: designing a specific form of the L1 adaptive controller of the longitudinal motion system as follows:
u_{ad}(s)=−kD(s)(\hat{η}(s)−k_{g}r(s))
wherein u_{ad}(t) is a combination of the longitudinal periodic variable pitch input quantity and the collective pitch input quantity, u_{ad}(s) is the Laplace transform of u_{ad}(t), r(s) is the Laplace transform of a command input r(t), \hat{η}(s) is the Laplace transform of \hat{η}(t), \hat{η}(t)=ω(t)u_{ad}(t)+\hat{θ}^{T}x_{θ}_{ᵥ}(t)+\hat{σ}(t); k_{g} is a gain of the command input, k_{g}=−1/(c_{θ}_{ᵥ}^{T}Aₘ⁻¹b_{θ}_{ᵥ}); D(s) is a strictly positive real transfer function,
$$D ( s ) = \frac{1}{s} ,$$
s expresses a s domain, and k is an adaptive feedback gain.
